(19) United States
(12) Patent Application Publication
(10) Pub. No.: US 2024/0427635 A1
(43) Pub. Date: Dec. 26, 2024

(54) DYNAMIC RESOURCE PREDICTION USING LARGE CODE LANGUAGE MODELS

(71) Applicant: Aurora Labs Ltd., Tel Aviv (IL)

(72) Inventors: Carmit Sahar, Tel Aviv (IL); Daniel Yellin, Raanana (IL); Stojancho Ganchev, Kavadarci (MK); Zohar Fox, Tel Aviv (IL)

(73) Assignee: Aurora Labs Ltd., Tel Aviv (IL)

(21) Appl. No.: 18/749,518

(22) Filed: Jun. 20, 2024

Related U.S. Application Data
(60) Provisional application No. 63/509,953, filed on Jun. 23, 2023.

(51) Int. Cl. G06F 9/50; G06F 8/41

(52) U.S. Cl. CPC G06F 9/5016; G06F 8/4442; G06F 2209/503

(57) ABSTRACT

Disclosed herein are techniques for dynamically predicting resource usage for code changes. Techniques include identifying an element of programming code; identifying a programming code execution environment; accessing a code language processing model, wherein the code language processing model has been trained to associate programming code execution tasks with amounts of computing resource usage; and predicting, without requiring execution of the element of programming code, an amount of computing resource usage associated with an execution of the element of programming code in the programming code execution environment.

### CROSS-REFERENCE TO RELATED APPLICATIONS

This application claims priority to U.S. Provisional Patent App. No. 63/509,953, filed on Jun. 23, 2023, which is incorporated herein by reference in its entirety.

### TECHNICAL FIELD

The subject matter described herein generally relates to techniques for providing, generating, training, and utilizing large code language models (LCLMs) for code analysis and other downstream applications. Such techniques may be applied to vehicle software and systems, as well as to various other types of Internet-of-Things (IoT) or network-connected systems that utilize controllers such as electronic control units (ECUs) or other controllers or devices. For example, certain disclosed embodiments are directed to tokenizing programming code and using the tokenized code as input for developing a code language processing model, usable for various analysis applications. Some disclosed embodiments are directed towards training a model based on a degree of functional similarity between two model outputs, where such training may cause the model to understand and/or predict functional code effects. Disclosed embodiments also include configuring and/or using models to predict computing resource usage, which may be based on learned functional effects. Additional embodiments involve configuring model input data and training customized models using hardware and/or software source attributes.

### BACKGROUND

Modern computing devices and systems, including personal computing devices and Internet of Things (IoT) systems, often operate using complicated and lengthy software instructions. Understanding, from a code language perspective, the functionality of this software can be useful for discerning various effects of the software and/or using this understanding to improve future versions of software. Many techniques, however, use natural language processing techniques, which fail to correctly understand code language, due in part to the natural language-based tokenization of model input. Existing techniques are also not capable of understanding contextual attributes within software programs that can significantly alter the functional effect of code, which current applications do not recognize. Moreover, existing techniques also fail to appreciate portions of code that appear textually different, but which may be similar or identical in functional effect, as well as the opposite scenarios where portions of code appear textually very similar, but may have very different effects.

In view of the technical deficiencies of current systems, there is a need for improved systems and methods for providing comprehensive code language analysis for computing devices and systems. The techniques discussed below offer many technological improvements in accuracy, efficiency, verifiability, and usability. For example, according to some techniques, a plurality of tokens are associated with portions of programming code. In some embodiments, tokens may be associated with respective semantically significant portions of code, allowing a model to achieve more sophisticated understandings of software, for which existing language models are ill-equipped. Additionally, some embodiments may utilize tokens that represent the same or similar information or functionality across different code languages, allowing for a more sophisticated model that can be trained with and also applied to multiple code languages. Disclosed embodiments also include token-based representations that are usable by an emulator, enabling emulation of code from multiple assembly dialects without requiring specifically tailored emulators.

Related advantages may result from disclosed methods involving training or updating code language processing models based on functional similarity of outputs. For example, degrees of functional similarity may be associated with outputs produced from different code segments, enabling a model to learn functionality and functional similarity associated the code segments, allowing for deeper analysis and description of software.

As yet another advantage, disclosed techniques include utilizing a code language processing model to determine computing resource usage associated with code. Some embodiments may achieve such a determination without requiring execution of the code, resulting in a high-insight low-strain outcome. Moreover, such embodiments involve tailoring a model to a specific programming code execution environment, or using a model tailored to a specific programming code execution environment, leading to even more accurate analysis of resource usage.

Disclosed embodiments also relate to generating code language processing models customized to specific hardware and/or specific software. For example, customized models may be generated by configuring model input data (e.g., training data) according to hardware and/or software source attributes. By shaping model input data prior to model training or configuration, the data may be used to produce a more accurate and/or efficient model that correctly understands code within the context of a specific hardware and/or software environment. Such models may also be updated with data associated with a same attribute, allowing for robust improvement of the model's code insight capabilities over time.

### SUMMARY

Some disclosed embodiments describe non-transitory computer-readable media, systems, and methods for creating and using tokens representing portions of programming code. For example, in an exemplary embodiment, a non-transitory computer-readable medium may include instructions that, when executed by at least one processor, cause the at least one processor to perform operations for creating and using tokens representing portions of programming code. The operations may comprise identifying a body of programming code; associating a plurality of tokens with respective portions of the body of programming code; configuring model input data for a code language processing model, the model input data comprising the plurality of tokens; and analyzing at least a part of the body of programming code using the code language processing model influenced by the model input data.

In accordance with further embodiments, the respective portions of the body of programming code include a functional code term, a code variable, and a code name.

In accordance with further embodiments, the respective portions of the body of programming code comprise at least one of a functional code term, a code variable, a code name, a keyword, a special character, a marker of a beginning of a statement, a marker of an end of a statement, a marker of a beginning of a block, a marker of an end of a block, a code class name, a code label name, a code array name, a code indexing variable, or a code pointer.

In accordance with further embodiments, the association of at least one of the tokens is based on one or more code compiler markers. In accordance with further embodiments, the one or more code compiler markers include at least one of a bracket, a parenthesis, a comma, a semicolon, a colon, a slash, or a tab.

In accordance with further embodiments, the operations further comprise identifying two different bodies of programming code having two different associated programming languages; identifying two different code portions from the two different bodies of programming code; determining that the two different code portions have a common meaning; and associating a single token with the two different code portions.

In accordance with further embodiments, the body of programming code comprises an uncompiled computer code program.

In accordance with further embodiments, the operations further comprise identifying a new body of programming code; applying the code language processing model to analyze the new body of programming code; and expressing at least a part of the new body of programming code using a plurality of tokens associated with the code language processing model. In accordance with further embodiments, the new body of programming code has an associated assembly language.

In accordance with further embodiments, analyzing the at least a part of the body of programming code comprises using the code language processing model to output an encapsulation of functionality of the at least a part of the body of programming code based on the model input data.

Further disclosed embodiments include a method for creating and using tokens representing portions of programming code. The method may comprise identifying a body of programming code; associating a plurality of tokens with respective portions of the body of programming code; configuring model input data for a code language processing model, the model input data comprising the plurality of tokens; and analyzing at least a part of the body of programming code using the code language processing model influenced by the model input data.

In accordance with further embodiments, the body of programming code comprises a plurality of different functional code terms, and each functional code term is associated with a different token.

In accordance with further embodiments, the body of programming code comprises a local variable and a global variable, and the method further comprises associating different tokens with the local variable and the global variable.

In accordance with further embodiments, the method further comprises associating a particular token with a particular one of the respective portions of the body of programming code, wherein the particular portion comprises a code class name.

In accordance with further embodiments, the method further comprises associating a particular token with a particular one of the respective portions of the body of programming code, wherein the particular portion comprises a code constant.

In accordance with further embodiments, the method further comprises associating a particular token with a particular one of the respective portions of the body of programming code, wherein the particular portion comprises a code label name.

In accordance with further embodiments, the method further comprises associating a particular token with a particular one of the respective portions of the body of programming code, wherein the particular portion comprises a code array name.

In accordance with further embodiments, the method further comprises associating a particular token with a particular one of the respective portions of the body of programming code, wherein the particular portion comprises a code indexing variable.

In accordance with further embodiments, the method further comprises associating a particular token with a particular one of the respective portions of the body of programming code, wherein the particular portion comprises a code pointer.

In accordance with further embodiments, the method further comprises associating a particular token with a particular one of the respective portions of the body of programming code, wherein the particular portion has no functional effect within the body of programming code.

In accordance with further embodiments, the body of programming code comprises a complete computer code program.

In accordance with further embodiments, the body of programming code comprises multiple complete computer code programs. In accordance with further embodiments, the complete computer code programs are associated with different respective source attributes. In accordance with further embodiments, the different respective source attributes comprise at least one of different respective hardware configurations, different respective operating systems, different respective programming languages, or different respective operating entities.

In accordance with further embodiments, the code language processing model is influenced by the model input data according to a model training process using the model input data.

In accordance with further embodiments, the plurality of tokens include at least one canonical representation of at least one of the respective portions of the body of programming code. In accordance with further embodiments, the at least one canonical representation is not uniquely associated with a single programming language.

In accordance with further embodiments, the method further comprises, after the analyzing, determining at least one canonical representation of at least one of the respective portions of the body of programming code. In accordance with further embodiments, the at least one canonical representation is not uniquely associated with a single programming language.

In another exemplary embodiment, a non-transitory computer-readable medium may include instructions that, when executed by at least one processor, cause the at least one processor to perform operations for training code language models. The operations may comprise making a plurality of programming code segments available to a code language processing model; providing an output of the code language processing model to one or more regression layers; determining, based on the one or more regression layers, a degree of functional similarity between two portions of the output; providing the degree of functional similarity to the code language processing model; and updating, based on the degree of functional similarity, the code language processing model.

In accordance with further embodiments, the output of the code language processing model is expressed as a vector.

In accordance with further embodiments, the output of the code language processing model is expressed as a plurality of vectors corresponding to a plurality of tokens. In accordance with further embodiments, the plurality of tokens correspond to the plurality of programming code segments.

In accordance with further embodiments, the degree of functional similarity is determined by feeding test values to programming code corresponding to the two portions of the output; comparing result values from the programming code based on the fed test values; and determining a degree of similarity between the compared result values. In accordance with further embodiments, the programming code corresponding to the two portions of the output is associated with a common number of inputs. In accordance with further embodiments, the programming code corresponding to the two portions of the output is associated with a different number of inputs. In accordance with further embodiments, the programming code corresponding to the two portions of the output is associated with a common number of outputs. In accordance with further embodiments, the programming code corresponding to the two portions of the output is associated with a different number of outputs.

In accordance with further embodiments, the programming code corresponding to the two portions of the output is associated with differing types of inputs.

Further disclosed embodiments include a method for training code language models. The method may comprise making a plurality of programming code segments available to a code language processing model; providing an output of the code language processing model to one or more regression layers; determining, based on the one or more regression layers, a degree of functional similarity between two portions of the output; providing the degree of functional similarity to the code language processing model; and updating, based on the degree of functional similarity, the code language processing model

In accordance with further embodiments, the method further comprises determining, based on the updated code language processing model, that two different segments from the plurality of programming code segments are functionally identical.

In accordance with further embodiments, the method further comprises determining, based on the updated code language processing model, that two different segments from the plurality of programming code segments have a similarity score above a threshold.

In accordance with further embodiments, the method further comprises determining, based on the updated code language processing model, a prediction of computing resources needed to execute one or more of the plurality of programming code segments.

In accordance with further embodiments, the method further comprises determining, based on the updated code language processing model, a dependency between two or more segments from the plurality of programming code segments.

In accordance with further embodiments, the method further comprises determining, based on the updated code language processing model, a vulnerability for a particular segment from the plurality of programming code segments.

In accordance with further embodiments, the method further comprises translating a particular segment from the plurality of programming code segments from one programming language into a different programming language.

In accordance with further embodiments, the code language processing model is trained based on the determined degree of functional similarity and a missing token training process.

In accordance with further embodiments, the degree of functional similarity is expressed as a likelihood.

In accordance with further embodiments, the degree of functional similarity is expressed as a score.

In accordance with further embodiments, the code language processing model comprises at least one neural network. In accordance with further embodiments, the at least one neural network is configured to use at least one attention mechanism. In accordance with further embodiments, the at least one neural network is configured to operate according to a transformer architecture.

In another exemplary embodiment, a non-transitory computer-readable medium may include instructions that, when executed by at least one processor, cause the at least one processor to perform operations for dynamically predicting resource usage for code changes. The operations may comprise identifying an element of programming code; identifying a programming code execution environment; accessing a code language processing model, wherein the code language processing model has been trained to associate programming code execution tasks with amounts of computing resource usage; and predicting, without requiring execution of the element of programming code, an amount of computing resource usage associated with an execution of the element of programming code in the programming code execution environment.

In accordance with further embodiments, the amount of computing resource usage is a function of processor cycles.

In accordance with further embodiments, the amount of computing resource usage is a function of memory utilization.

In accordance with further embodiments, the amount of computing resource usage is a function of time.

In accordance with further embodiments, the amount of computing resource usage is a function of a number of processors.

In accordance with further embodiments, the amount of computing resource usage is a function of pipeline usage.

In accordance with further embodiments, the amount of computing resource usage is a function of at least one of cache misses or cache hits.

In accordance with further embodiments, the programming code execution environment has a defined type of processor.

In accordance with further embodiments, the programming code execution environment has a defined type of hardware device.

In accordance with further embodiments, the programming code execution environment has a defined memory space.

Further disclosed embodiments include a method for dynamically predicting resource usage for code changes. The method may comprise identifying an element of programming code; identifying a programming code execution environment; accessing a code language processing model, wherein the code language processing model has been trained to associate programming code execution tasks with amounts of computing resource usage; and predicting, without requiring execution of the element of programming code, an amount of computing resource usage associated with an execution of the element of programming code in the programming code execution environment.

In accordance with further embodiments, the code language processing model has been trained to associate programming code execution tasks with amounts of computing resource usage in the programming code execution environment.

In accordance with further embodiments, the predicting includes matching the element of programming code to an identical match in the code language processing model.

In accordance with further embodiments, the predicting includes matching the element of programming code to a nearest, non-identical match in the code language processing model.

In accordance with further embodiments, the predicting includes matching the programming code execution environment to an identical match in the code language processing model.

In accordance with further embodiments, the predicting includes matching the programming code execution environment to a nearest, non-identical match in the code language processing model.

In accordance with further embodiments, the predicting is expressed as a range of values.

In accordance with further embodiments, the predicting is expressed as at least one of a minimum or maximum value.

In accordance with further embodiments, the code language processing model comprises one or more feed-forward neural networks (FFNs). In accordance with further embodiments, each of the one or more FFNs is configured to predict a particular attribute of computing resource usage.

In accordance with further embodiments, the code language processing model comprises at least one neural network. In accordance with further embodiments, the at least one neural network is configured to use at least one attention mechanism. In accordance with further embodiments, the at least one neural network is configured to operate according to a transformer architecture.

In another exemplary embodiment, a non-transitory computer-readable medium may include instructions that, when executed by at least one processor, cause the at least one processor to perform operations for creating and using tokens representing portions of programming code. The operations may comprise identifying a first body of programming code associated with a hardware or software source attribute; associating a plurality of tokens with respective portions of the first body of programming code; configuring model input data for training a code language processing model customized in accordance with the hardware or software source attribute, the model input data comprising the plurality of tokens; and training, using the model input data, the code language processing model to analyze at least a part of the first body of programming code or a part of a second body of programming code, thus producing a customized and trained code language processing model in accordance with the hardware or software source attribute.

In accordance with further embodiments, the hardware or software source attribute comprises at least one of: a particular hardware configuration, a particular operating system, a particular programming language, a particular software project, or a particular operating entity.

In accordance with further embodiments, the first and second bodies of programming code are associated with a common hardware configuration. In accordance with further embodiments, the common hardware configuration comprises a common device or a common system.

In accordance with further embodiments, the first and second bodies of programming code are associated with a common operating system.

In accordance with further embodiments, the first and second bodies of programming code are associated with a common programming language.

In accordance with further embodiments, the first and second bodies of programming code are associated with a common software project.

In accordance with further embodiments, the first and second bodies of programming code are associated with a common operation entity.

In accordance with further embodiments, the operations further comprise analyzing, using the code language processing model, the at least a part of the first body of programming code.

In accordance with further embodiments, the operations further comprise analyzing, using the code language processing model, the at least a part of the second body of programming code.

Further disclosed embodiments include a method for creating and using tokens representing portions of programming code. The method may comprise identifying a first body of programming code associated with a hardware or software source attribute; associating a plurality of tokens with respective portions of the first body of programming code; configuring model input data for training a code language processing model customized in accordance with the hardware or software source attribute, the model input data comprising the plurality of tokens; and training, using the model input data, the code language processing model to analyze at least a part of the first body of programming code or a part of a second body of programming code, thus producing a customized and trained code language processing model in accordance with the hardware or software source attribute.

In accordance with further embodiments, the hardware or software source attribute comprises at least one of: a particular hardware configuration, a particular operating system, a particular programming language, a particular software project, or a particular operating entity.

In accordance with further embodiments, the first and second bodies of programming code are associated with a common hardware configuration. In accordance with further embodiments, the same hardware configuration comprises a common device or a same system.

In accordance with further embodiments, the first and second bodies of programming code are associated with a common operating system.

In accordance with further embodiments, the first and second bodies of programming code are associated with a common programming language.

In accordance with further embodiments, the first and second bodies of programming code are associated with a common software project.

In accordance with further embodiments, the first and second bodies of programming code are associated with a common operation entity.

In accordance with further embodiments, the method further comprises analyzing, using the code language processing model, the at least a part of the first body of programming code.

In accordance with further embodiments, the method further comprises analyzing, using the code language processing model, the at least a part of the second body of programming code.

In another exemplary embodiment, a non-transitory computer-readable medium may include instructions that, when executed by at least one processor, cause the at least one processor to perform operations for creating and using tokens representing portions of programming code. The operations may comprise identifying a body of programming code; associating a plurality of tokens with respective portions of the body of programming code, wherein the associating comprises determining at least one canonical representation of at least one of the respective portions of the body of programming code; configuring model input data for a code language processing model, wherein the model input data comprises the plurality of tokens including the at least one canonical representation; and analyzing at least a part of the body of programming code using the code language processing model influenced by the model input data.

In accordance with further embodiments, determining the at least one canonical representation comprises determining the at least one canonical representation from among a plurality of canonical representations, each of the canonical representations representing multiple programming code elements.

In accordance with further embodiments, the multiple programming code elements are associated with different programming languages.

In accordance with further embodiments, the multiple programming code elements are associated with different bodies of programming code.

In accordance with further embodiments, associations between the multiple programming code elements and the canonical representations are determined using the code language processing model.

In accordance with further embodiments, the associations between the multiple programming code elements and the canonical representations are determined by applying the code language processing model to the different bodies of programming code.

In accordance with further embodiments, the at least one canonical representation represents different code elements with a same functionality.

In accordance with further embodiments, the at least one canonical representation represents different code elements with functionalities within a similarity threshold range.

In accordance with further embodiments, the operations further comprise identifying a portion of the body of programming code for token designation.

In accordance with further embodiments, the operations further comprise: determining functionality of the identified portion; and based on the functionality, designating a new token for association with the identified portion.

In accordance with further embodiments, the at least one canonical representation of at least one of the respective portions of the body of programming code is based on at least one of: comparing instruction sets for different assembly dialects and determining an overlap of the instruction sets; or compiling a programming code portion into multiple assembly dialects to generate multiple instruction sets.

Further disclosed embodiments include a method for using tokens representing portions of programming code. The method may comprise identifying a body of programming code; associating a plurality of tokens with respective portions of the body of programming code, wherein the associating comprises determining at least one canonical representation of at least one of the respective portions of the body of programming code; configuring model input data for a code language processing model, wherein the model input data comprises the plurality of tokens including the at least one canonical representation; and analyzing at least a part of the body of programming code using the code language processing model influenced by the model input data.

In accordance with further embodiments, determining the at least one canonical representation comprises determining the at least one canonical representation from among a plurality of canonical representations, each of the canonical representations representing multiple programming code elements.

In accordance with further embodiments, the multiple programming code elements are associated with different programming languages.

In accordance with further embodiments, wherein the multiple programming code elements are associated with different bodies of programming code.

In accordance with further embodiments, associations between the multiple programming code elements and the canonical representations are determined using the code language processing model.

In accordance with further embodiments, associations between the multiple programming code elements and the canonical representations are determined by applying the code language processing model to the different bodies of programming code.

In accordance with further embodiments, the at least one canonical representation represents different code elements with a same functionality.

In accordance with further embodiments, the at least one canonical representation represents different code elements with functionalities within a similarity threshold range.

In accordance with further embodiments, the method further comprises identifying a portion of the body of programming code for token designation.

In accordance with further embodiments, the method further comprises determining functionality of the identified portion; and based on the functionality, designating a new token for association with the identified portion.

In accordance with further embodiments, the at least one canonical representation of at least one of the respective portions of the body of programming code is based on at least one of: comparing instruction sets for different assembly dialects and determining an overlap of the instruction sets; or compiling a programming code portion into multiple assembly dialects to generate multiple instruction sets.

In another exemplary embodiment, a non-transitory computer-readable medium may include instructions that, when executed by at least one processor, cause the at least one processor to perform operations for creating and using tokens representing portions of programming code. operations may comprise identifying a body of programming code; associating a plurality of tokens with respective portions of the body of programming code to generate a token-based representation of the body of programming code, wherein the associating comprises determining at least one canonical representation of at least one of the respective portions of the body of programming code; providing the token-based representation of the body of programming code to an emulator, the emulator being configured to interpret token-based representations; and receiving, from the emulator, an emulation result.

In accordance with further embodiments, the emulator is not configured to interpret assembly language.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors, which may be part of a device or system and/or configured as special-purpose processor(s), based on software instructions that are programmed with logic and instructions that perform, when executed, one or more operations consistent with the disclosed embodiments. Moreover, aspects of the disclosed embodiments may be performed as part of a method. For example, an operation performable by a processor according to an executable instruction stored in include a tangible computer-readable medium may be included as a step within a method.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 illustrates an exemplary pictographic representation of a network architecture for providing analysis and modeling benefits to devices, consistent with embodiments of the present disclosure.

FIG. 2 illustrates an exemplary pictographic representation of a modeler system, consistent with embodiments of the present disclosure.

FIG. 3 illustrates an exemplary pictographic representation of a computing device, consistent with embodiments of the present disclosure.

FIG. 4 illustrates an exemplary pictographic representation of a layered model architecture, consistent with embodiments of the present disclosure.

FIG. 5 depicts a flowchart of an exemplary process for creating and using tokens representing portions of programming code, consistent with embodiments of the present disclosure.

FIG. 6 depicts a flowchart of an exemplary process for training code language models, consistent with embodiments of the present disclosure.

FIG. 7 depicts a flowchart of an exemplary process for dynamically predicting resource usage for code changes, consistent with embodiments of the present disclosure.

FIG. 8 depicts a flowchart of an exemplary process for creating and using tokens representing portions of programming code, consistent with embodiments of the present disclosure.

FIG. 9 depicts a flowchart of another exemplary process for creating and using tokens representing portions of programming code, consistent with embodiments of the present disclosure.

### DETAILED DESCRIPTION OF EXEMPLARY EMBODIMENTS

Reference will now be made in detail to exemplary embodiments, examples of which are illustrated in the accompanying drawings and disclosed herein. Wherever convenient, the same reference numbers will be used throughout the drawings to refer to the same or like parts. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

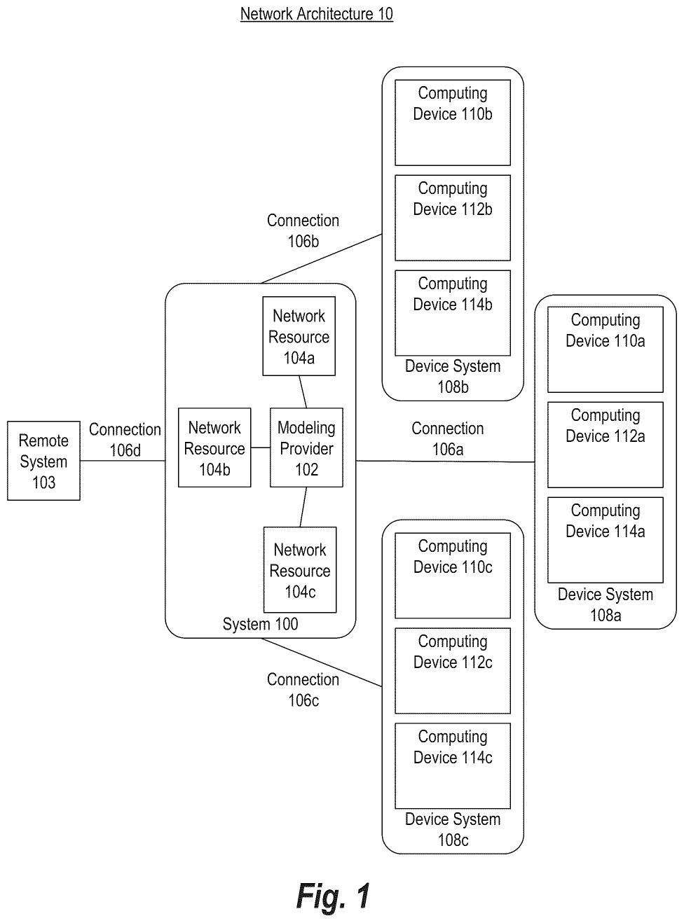

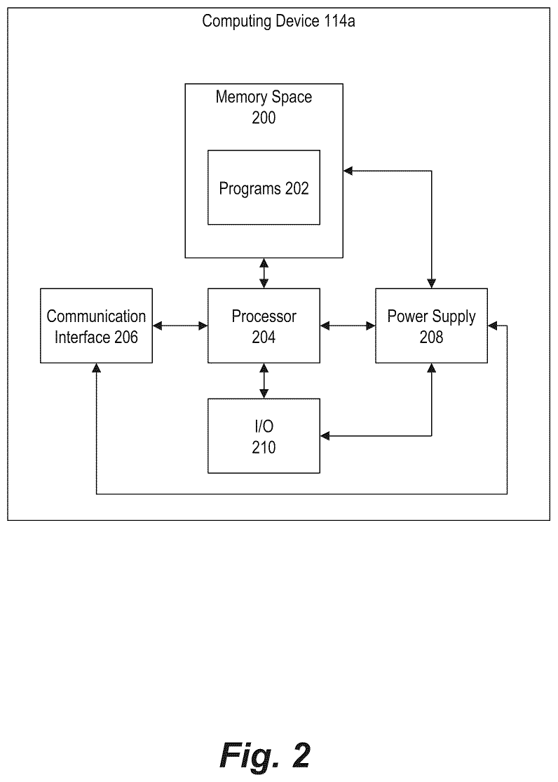

FIG. 1 illustrates an exemplary pictographic representation of network architecture 10, which may include a system 100. System 100 may be maintained, for example, by an artificial intelligence (AI) analysis provider, a security provider, software developer, an entity associated with developing or improving computer software, or any combination of these entities. System 100 may include a modeling provider 102, which may be a single device or combination of devices, and is described in further detail with respect to FIG. 2. Modeling provider 102 may be in communication with any number of network resources, such as network resources 104a, 104b, and/or 104c. A network resource may be a database, supercomputer, general purpose computer, special purpose computer, virtual computing resource (e.g., a virtual machine or a container), graphics processing unit (GPU), or any other data storage or processing resource.

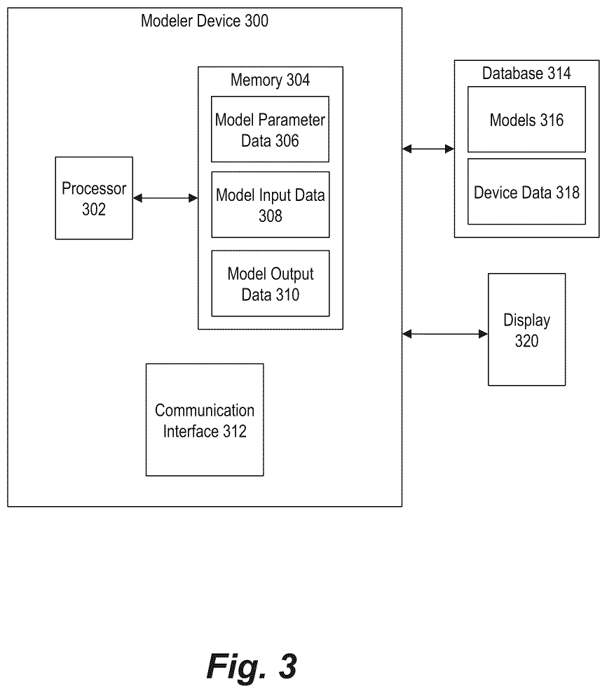

Network architecture 10 may also include any number of device systems, such as device systems 108a, 108b, and 108c. A device system may be, for example, a computer system, a home security system, a parking garage sensor system, a vehicle, an inventory monitoring system, a connected appliance, telephony equipment, a network routing device, a smart power grid system, a drone or other unmanned vehicle, a hospital monitoring system, any Internet of Things (IoT) system, or any arrangement of one or more computing devices. A device system may include devices arranged in a local area network (LAN), a wide area network (WAN), or any other communications network arrangement. Further, each controller system may include any number of devices, such as controllers. For example, exemplary device system 108a includes computing devices 110a, 112a, and 114a, one or more of which may be controllers, which may have the same or different functionalities or purposes. These devices are discussed further through the description of exemplary computing device 114a, discussed with respect to FIG. 3. Device systems 108a, 108b, and 108c may connect to system 100 through connections 106a, 106b, and 106c, respectively. System 100 may also connect through connection 106d to a remote system 103, which may include any number of computing devices (e.g., one or more servers, personal desktop computers, computing machines). Remote system 103 may be associated with a creator of code, a manufacturer of a physical component and/or device (e.g., controller), a system (e.g., vehicle) manufacturer, or another entity associated with developing and/or deploying software. In some embodiments, remote system 103 may also connect to a device system (e.g., device system 108a), such as through a connection separate from connection 106d. In some embodiments, system 100 may provide digital information to remote system 103 based on operations performed by system 100 (e.g., as discussed with respect to the figures below). A connection 106 (exemplified by connections 106a, 106b, 106c, and 106d) may be a communication channel, which may include a bus, a cable, a wireless (e.g., over-the-air) communication channel, a radio-based communication channel, a local area network (LAN), the Internet, a wireless local area network (WLAN), a wide area network (WAN), a cellular communication network, or any Internet Protocol (IP) based communication network and the like. Connections 106a, 106b, 106c, and 106d may be of the same type or of different types, and may include combinations of types (e.g., the Internet and a LAN).

Any combination of components of network architecture 10 may perform any number of steps of the exemplary processes discussed herein, consistent with the disclosed exemplary embodiments.

FIG. 2 illustrates an exemplary pictographic representation of computing device 114a, which may be a computer, a server, an IoT device, or a controller. For example, computing device 114a may be an automotive controller, such as an electronic control unit (ECU) (e.g., manufactured by companies such as Bosch™, Delphi Electronics™, Continental™, Denso™, etc.), or may be a non-automotive controller, such as an IoT controller manufactured by Skyworks™, Qorvo™, Qualcomm™, NXP Semiconductors™, etc. Computing device 114a may be configured (e.g., through programs 202) to perform a single function (e.g., a braking function in a vehicle), or multiple functions. Computing device 114a may perform any number of steps of the exemplary processes discussed herein, consistent with the disclosed exemplary embodiments.

Computing device 114a may include a memory space 200 and a processor 204. Memory space 200 may include a single memory component, or multiple memory components. Such memory components may include an electronic storage device, a magnetic storage device, an optical storage device, an electromagnetic storage device, a semiconductor storage device, or any suitable combination of the foregoing. For example, memory space 200 may include any number of hard disks, random access memories (RAMs), read-only memories (ROMs), erasable programmable read-only memories (EPROMs or Flash memories), and the like. Memory space 200 may include one or more storage devices configured to store instructions usable by processor 204 to perform functions related to the disclosed embodiments. For example, memory space 200 may be configured with one or more software instructions, such as software program(s) 202 or code segments that perform one or more operations when executed by processor 204 (e.g., the operations discussed in connection with figures below). The disclosed embodiments are not limited to separate programs or computers configured to perform dedicated tasks. For example, memory space 200 may include a single program or multiple programs that perform the functions associated with network architecture 10. Memory space 200 may also store data that is used by one or more software programs (e.g., data relating to controller functions, data obtained during operation of the vehicle, or other data).

In certain embodiments, memory space 200 may store software executable by processor 204 to perform one or more methods, such as the methods discussed below. The software may be implemented via a variety of programming techniques and languages, such as C or MISRA-C, ASCET, Simulink, Stateflow, and various others. Further, it should be emphasized that techniques disclosed herein are not limited to automotive embodiments. Various other IoT environments may use the disclosed techniques, such as smart home appliances, network security or surveillance equipment, smart utility meters, connected sensor devices, parking garage sensors, and many more. In such embodiments, memory space 200 may store software based on a variety of programming techniques and languages such as C, C+, C++, C#, PHP, Java, JavaScript, Python, and various others.

Processor 204 may include one or more dedicated processing units, application-specific integrated circuits (ASICs), field-programmable gate arrays (FPGAs), graphical processing units, or various other types of processors or processing units coupled with memory space 200.

Computing device 114a may also include a communication interface 206, which may allow for remote devices to interact with computing device 114a. Communication interface 206 may include an antenna or wired connection to allow for communication to or from computing device 114a. For example, an external device (such as computing device 114b, computing device 116a, modeling provider 102, or any other device capable of communicating with computing device 114a) may send code to computing device 114a instructing computing device 114a to perform certain operations, such as changing software stored in memory space 200.

Computing device 114a may also include power supply 208, which may be an AC/DC converter, DC/DC converter, regulator, or battery internal to a physical housing of computing device 114a, and which may provide electrical power to computing device 114a to allow its components to function. In some embodiments, a power supply 208 may exist external to a physical housing of a computing device (i.e., may not be included as part of computing device 114a itself), and may supply electrical power to multiple computing devices (e.g., all controllers within a controller system, such as a device system 108a).

Computing device 114a may also include input/output device (I/O) 210, which may be configured to allow for a user or device to interact with computing device 114a. For example, I/O 210 may include at least one of wired and/or wireless network cards/chip sets (e.g., WiFi-based, cellular based, etc.), an antenna, a display (e.g., graphical display, textual display, etc.), an LED, a router, a touchscreen, a keyboard, a microphone, a speaker, a haptic device, a camera, a button, a dial, a switch, a knob, a transceiver, an input device, an output device, or another I/O device configured to perform, or to allow a user to perform, any number of steps of the methods of the disclosed embodiments, as discussed further below. While FIG. 2 depicts exemplary computing device 114a, these described aspects of computing device 114a (or any combination thereof) may be equally applicable to any other device in network architecture, such as computing device 110b, computing device 110c, modeling provider 102, or network resource 104a.

FIG. 3 illustrates an exemplary pictographic representation of modeling provider 102, which may be a single device or multiple devices. In the embodiment shown, modeling provider 102 includes a modeler device 300, which may be a computer, server, mobile device, special purpose computer, or any other computing device that may allow a user to perform any number of steps of the methods of the disclosed embodiments, as discussed further below. For example, modeler device 300 may include a processor 302, which may be configured to execute instructions stored at memory 304. Memory 304 may include multiple memory components (e.g., a hard drive, a solid state drive, flash memory, random access memory) and/or partitions. Memory 304 may also store data (e.g., instructions) to be used in methods of the disclosed embodiments, as discussed further below.

Memory 304 may include one or more datasets, which may be used to, for example, initialize, train, configure, update, reconfigured, and/or run a model (e.g., a machine learning model). For example, memory 304 may include model parameter data 306, which may include one or more parameters (e.g., hyperparameters, seed values, initialization parameters, node configurations, layer configurations, weight values, tokens) that may be usable to influence the configuration of a model. Memory 304 may also include model input data 308, which may include one or more data elements (e.g., values, vectors, matrices, strings, tokens) that may be configured to input to a model. Model input data 308 may include and/or be based upon programming code element, consistent with embodiments discussed herein. Memory 304 may also include model output data 310, which may include data output from a model (e.g., one or more values, vectors, matrices, strings, and/or probabilities). For example, model output data 310 may include a predictive value representing a probability of digital information being true and/or a highest probability amount multiple probabilities (e.g., a probability associated with digital information predicted to achieve maximization of a metric).

In some embodiments, modeler device 300 may connect to a communication interface 312, which may be similar to communication interface 206 and/or I/O 210, described above. For example, communication interface 312 may include at least one of wired and/or wireless network cards/chip sets (e.g., WiFi-based, cellular based, etc.), an antenna, a display (e.g., graphical display, textual display, etc.), an LED, a router, a touchscreen, a keyboard, a mouse, a microphone, a speaker, a haptic device, a camera, a button, a dial, a switch, a knob, a transceiver, an input device, an output device, or another device configured to perform, or to allow a user to perform, any number of steps of the methods of the disclosed embodiments, as discussed further below. Communication interface 312 may also allow modeler device 300 to connect to other devices, such as other devices within modeling provider 102, other devices within a system 100, and/or devices external to system 100, such as a computing device 114a. In some embodiments, communication interface 312 (e.g., a network adapter, an ethernet interface, an antenna) may connect with database 314, which may also be connectable to a device other than modeler device 300 (e.g., a device external to system 100), to communicate with database 314.

Modeler device 300 may also connect to database 314, which may be an instance of a network resource, such as network resource 104a. Database 314 may store data to be used in methods of the disclosed embodiments, as discussed further below. For example, database 314 may maintain any number of models 316, which may be fully trained, partially trained, or untrained. Models 316 may be associated with respective specific input data, devices, and/or entities, consistent with the disclosed embodiments. Models 316 may include one or more of a statistical model, a regression model (e.g., one or more regression layers), a probabilistic model, a language model, an encoder-decoder model, a transformer model, a neural network (e.g., one or more neural network layers, a recurrent neural network, also called an RNN), a bag-of-words model, a Word2Vec model, a sequence-to-sequence model, or any other AI-based digital tool. It is appreciated that the human mind is not equipped to perform the operations for which model 316 is configured, given its arrangement and combination of model elements (e.g., nodes, layers, parameters, connections), as further demonstrated in model architecture 400. A model 316 may include a code language processing model, or any other model discussed herein.

Database 314 may include any number of disk drives, servers, server arrays, server blades, memories, or any other medium capable of storing data. Database 314 may be configured in a number of fashions, including as a textual database, a centralized database, a distributed database, a hierarchical database, a relational database (e.g., SQL), an object-oriented database, or in any other configuration suitable for storing data. While database 314 is shown externally to modeling provider 102 (e.g., existing at a remote cloud computing platform, for example), it may also exist internally to it (e.g., as part of memory 304).

In some embodiments, database 314 may include device data 318, which may include operational data (e.g., log data) and/or program data (e.g., compiled code, uncompiled code, an executable program, an application) associated with one or more devices. In some embodiments, device data 318 may be in a format that is unrecognizable to a model, and may be converted to a format, arrangement, or representation that a model is configured to receive as input (e.g., model input data 308), which may bear no resemblance to the initial format and may not be understandable to a human.

Modeler device 300 may also be communicably connectable with a display 220, which may include a liquid crystal display (LCD), in-plane switching liquid crystal display (IPS-LCD), light-emitting diode (LED) display, organic light-emitting diode (OLED) display, active-matrix organic light-emitting diode (AMOLED) display, cathode ray tube (CRT) display, plasma display panel (PDP), digital light processing (DLP) display, or any other display capable of connecting to a user device and depicting information to a user. Display 320 may display graphical interfaces, interactable graphical elements, animations, dynamic graphical elements, and any other visual element, such as visual elements indicating digital information associated with a model (e.g., associated with training a model or model output), among others.

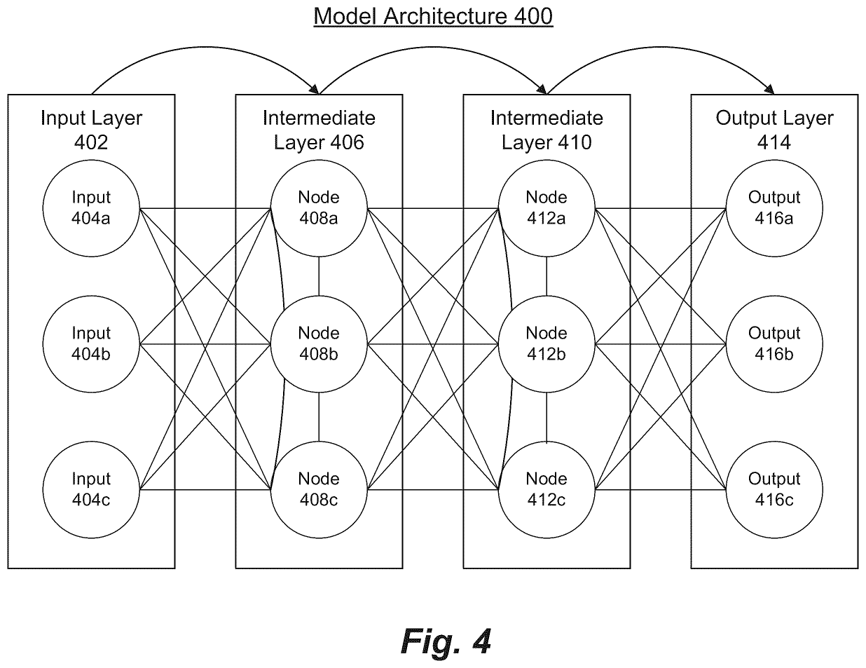

FIG. 4 illustrates an exemplary pictographic representation of a model architecture 400. Model architecture 400 may represent a structure for a model (e.g., a model 316, which may be an AI model), though many variations are possible, which may or may not include elements shown in FIG. 4. Model architecture 400 may include a number of model layers, which may be organized in a sequence or other arrangement, such as within a neural network or other machine learning model. A model layer may be, for example, a regression layer, a convolution layer, a deconvolution layer, a fully connected layer, a partially connected layer, a recurrent layer, a pooling layer, an activation layer, a sequence layer, a normalization layer, a resizing layer, a pooling layer, an unpooling layer, or a dropout layer. For example, model architecture 400 may include an input layer 402, which may include and/or be configured to receive one or more model inputs, such as input 404a, input 404b, and input 404c (which may be considered nodes), consistent with disclosed embodiments. Of course, other numbers or configurations of input layers and inputs are possible.

Model architecture 400 may also include one or more intermediate layers, such as intermediate layer 406 and intermediate layer 410. An intermediate layer may include one or more nodes, which may be connected (e.g., artificially neurally connected) to another node, layer, input, and/or output. For example, intermediate layer 406 may include nodes 408a, 408b, and 408c, which are shown with exemplary connections to input 404a, input 404b, input 404c, as well as to nodes included in intermediate layer 410-node 412a, node 412b, and node 412c. Of course, other numbers or configurations of intermediate layers and nodes are possible.

Model architecture 400 may also include an output layer 414, which may include one or more outputs and/or be configured to generate one or more model outputs, such as output 416a, output 416b, and output 416c (which may be considered nodes). One or more of the outputs may include or represent analysis of programming code, a prediction associated with programming code, or any other modeled aspect of programming code, consistent with disclosed embodiments. As depicted in FIG. 4, inputs to a layered architecture may be influenced by a complex interconnected web of connections between nodes. In some embodiments, the connections may represent unidirectional relationships, bidirectional relationships, dependent relationships, interdependent relationships, correlative relationships, or any combination thereof. In some embodiments, one or more nodes may be activated or deactivated, which may be dependent on initialization parameters and/or training parameters of a model. A training parameter may include, for example, a number of nodes, a configuration of nodes, types of nodes within the configuration, a number of layers, a configuration of layers, types of nodes within the layers, a number of training epochs, a sequence of training operations, or any other digital information that can influence the performance of training a model. In some embodiments, different nodes (or other model parameters) may be associated with different weights (which may also be considered a model parameter). The exemplary processes described below may be carried out using a model including any or all aspects of model architecture 400. Nodes and layers may be considered model parameters. As shown in FIG. 4, different nodes in different layers, or the same layer, may be connected in a number of different ways. The connections shown are exemplary, and fewer or additional connections may exist.

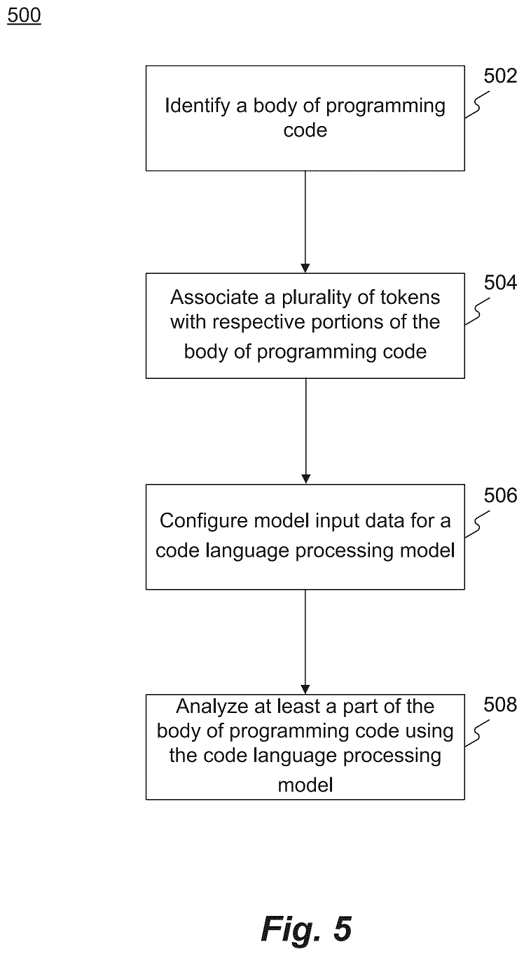

FIG. 5 shows an exemplary process 500 for creating and using tokens representing portions of programming code. In accordance with disclosed embodiments, process 500 may be implemented in system 100 depicted in FIG. 1, or any type of network environment. For example, process 500 may be performed by at least one processor (e.g., processor 302), memory (e.g., memory 304), and/or other components of modeling provider 102 (e.g., components of one or more modeler devices 300), or by any computing device or IoT system. All or part of process 500 may be implemented in conjunction with all or part of other processes discussed herein (e.g., process 600, process 700, process 800, and/or process 900). For example, analysis results associated with step 508 may be provided as output of the code language processing model at step 604. As another example, prediction performed at step 708 may be based on analysis results associated with step 508. As yet another example, associating the plurality of tokens with the respective portions of the body of programming code may generate a token-based representation of the body of programming code, as discussed with respect to step 904.

At step 502, process 500 may identify a body of programming code. The body of programming code may include one or more of a program, a script, a module, a symbol, a file, binary code, compiled code, uncompiled code, executable code, unexecutable code, any combination thereof, or any amount of computer code (e.g., controller code). For example, the body of programming code may include an uncompiled computer code program. As another example, the body of programming code may include a complete computer code program (e.g., compiled or uncompiled). As yet another example, the body of programming code may include multiple complete computer code programs, which may be associated with different respective source attributes. Different respective source attributes may include at least one of different respective hardware configurations, different respective operating systems, different respective programming languages, or different respective operating entities. In some embodiments, the multiple complete computer code programs may include only different respective source attributes, only the same respective source attributes, or a combination of the same respective source attributes and different respective source attributes. In this way, process 500 may be able to achieve enhanced analysis and/or model training (both discussed below) by leveraging multiple complete computer code programs, which may allow for the generation of more AI perceptions.

Identifying a body of programming code may include one or more of requesting, receiving, verifying, retrieving (e.g., from local or remote storage), extracting, converting, or reformatting the body of programming code. For example, identifying a body of programming code may include receiving the body of programming code from a remote source (e.g., system 100 may receive the body of programming code from remote system 103). A symbol may include one or more of a function, an argument, a call, an object, a buffer, a variable, a command, an instruction, a method (e.g., object-oriented programming method), a module, a table, or a segment of code. As another example, identifying a body of programming code may include converting the body of programming code from one format to another, such as by converting compiled code to uncompiled code.

In some embodiments, the body of programming code may include multiple portions (e.g., respective portions, as referred to in step 504). Portions of the body of programming code may include at least one of a symbol, executable code, unexecutable code, compiled code, uncompiled code, a line of code, a semantically distinct code segment, or any combination thereof. Additionally or alternatively, portions (e.g., respective portions) of the body of programming code may include at least one of a functional code term (e.g., an argument, an operator, a function), a code variable, a code name, a keyword, a special character, a marker of a beginning of a statement, a marker of an end of a statement, a marker of a beginning of a block, a marker of an end of a block, a code class name, a code label name, a code array name, a code indexing variable, or a code pointer. In some embodiments, the respective portions of the body of programming code may include a functional code term (e.g., a function), a code variable, and a code name (e.g., the name of a function). In some embodiments, the body of programming code may include a local variable and a global variable.

In some embodiments, the body of programming code may include a plurality of different functional code terms and/or a plurality of different portions. A portion (e.g., a functional code term) may be considered different if it is different in type, different in content, different in effect, different in expression, different in placement, or any combination thereof.

At step 504, process 500 may associate a plurality of tokens with respective portions of the body of programming code. A token may include a string (e.g., a string of Unicode characters), a symbol, a vector, or any other digital identifier generated to uniquely identify digital information (e.g., a portion of a body of programming code). A token may be unique with respect to a plurality of other tokens, any or all of which may be stored in a token library. A token may also be unique with respect to tokens representing one body of programming code or tokens representing multiple bodies of programming code. In embodiments where the body of programming code includes different functional code terms, each functional code term may be associated with a different token. For example, step 504 may include associating different tokens with a local variable and a global variable.

Associating a token with a portion of the body of programming code may include linking the token with the portion of the body of programming code within a data structure, generating metadata for the token and/or portion of the body of programming code (e.g., metadata for the token that identifies the portion of the body of programming code or visa versa), editing a token library, replacing the portion of the body of programming code with the token (e.g., within a copy of the body of programming code), generating a complete or partial tokenized representation of the body of programming code (e.g., by replacing multiple portions of the body of programming code with respective symbols), or any other digital activity that identifies the token as relevant to the portion of the body of programming code. In some embodiments, the association of at least one of the tokens may be based on one or more code compiler markers, which may be particular characters or combinations of characters in the body of programming code. In some embodiments, the one or more code compiler markers include at least one of a bracket, a parenthesis, a comma, a semicolon, a colon, a slash, or a tab. For example, process 500 may use one or more code compiler markers as division points between portions of the body of programming code to be associated with tokens (e.g., tokenized). In some embodiments, process 500 may determine whether to designate a code compiler marker as a division point based on characters that precede and/or follow after the code compiler marker. For example, process 500 may determine that an open bracket (“{”) should be designated as a division point, but then may not designate another division point until identifying a closed bracket (“}”) after the open bracket (which may then also be designated as a division point, such as for a function). In some embodiments, different combinations of characters may trigger process 500 to apply different division points. For example, process 500 may detect a combination of alphanumeric characters followed by an open parenthesis, followed by more alphanumeric characters, followed by a comma (e.g., “function1 (argument1,”), and may designate the open parenthesis as a division point between a function name and an argument (e.g., argument1) and may designate the comma as a division point between two arguments.

In some embodiments, process 500 may include a particular portion of the body of programming code with a particular token. As one non-limiting and non-exclusive example, step 504 may include associating a particular token with a particular one of the respective portions of the body of programming code that includes a code class name. As a second non-limiting and non-exclusive example, step 504 may include associating a particular token with a particular one of the respective portions of the body of programming code that includes a code constant. As a third non-limiting and non-exclusive example, step 504 may include associating a particular token with a particular one of the respective portions of the body of programming code that includes a code label name. As a fourth non-limiting and non-exclusive example, step 504 may include associating a particular token with a particular one of the respective portions of the body of programming code that includes a code array name. As a fifth non-limiting and non-exclusive example, step 504 may include associating a particular token with a particular one of the respective portions of the body of programming code that includes a code indexing variable. As a sixth non-limiting and non-exclusive example, step 504 may include associating a particular token with a particular one of the respective portions of the body of programming code that includes a code pointer. As a seventh non-limiting and non-exclusive example, step 504 may include associating a particular token with a particular one of the respective portions of the body of programming code that has no functional effect within the body of programming code (e.g., a comment, a title).

In some embodiments, process 500 may include identifying two different bodies of programming code having two different associated programming languages; identifying two different code portions from the two different bodies of programming code; determining that the two different code portions have a common meaning; and associating a single token with the two different code portions. A common meaning may include a common programming meaning (e.g., code semantics) and/or a common functional effect.

In some embodiments, the plurality of tokens may include at least one canonical representation of at least one of the respective portions of the body of programming code. A canonical representation may include a representation that is applicable across different bodies of programming code and/or across different portions of the same body of programming code. For example, a canonical representation may include a representation that indicates a single functional effect or code-semantic meaning that can be associated with multiple portions of programming code that appear different (e.g., when viewed as uncompiled code or compiled code). In some embodiments, the at least one canonical representation may not be uniquely associated with a single programming language. In this manner, a code language processing model may be able to perform analysis across multiple bodies of programming code and/or programming languages, leading to generation of additional or more insightful AI perceptions. Canonical representations may also allow for faster and more accurate comparisons and/or conversion between code written in different programming languages. In some embodiments, process 500 may associate a token with a portion of the body of programming code based on a previous association. For example, process 500 may determine that one portion of a first body of programming code is functionally equivalent to a portion of a second body of programming code with which a token is associated, and may associate the same token with the one portion of the first body of programming code. By detecting functional overlap, process 500 may be able to maintain a smaller token library, saving memory space while still allowing for robust analysis across multiple bodies of programming code.

In some embodiments, process 500 may refrain from associating a token with a portion of the body of programming code, which may be a non-functional portion of code text or information that would disrupt the analytical abilities of the code language processing model. For example, process 500 may refrain from associating a token with a comment in the body of programming code, or other nonexecutable portion.

At step 506, process 500 may configure model input data for a code language processing model. Model input data may include one or more of a vector, a matrix, a token, a file, programming code (e.g., the portion of the body of programming code), a model parameter, or any other digital information for influencing analysis performable by the code language processing model. The code language processing model may be a model 316 (discussed above) and/or may incorporate any aspect of model architecture 400. Configuring model input data may include one or more of accessing (e.g., requesting, identifying, receiving, retrieving, and/or determining) a client device input, accessing (e.g., requesting, identifying, receiving, retrieving, and/or determining) model input data, converting model input data (e.g., converting model input data into a digital format interpretable by the code language processing model, which may be uninterpretable by a human), synthesizing model input data, grouping model input data (e.g., within a matrix), discarding a portion of model input data (e.g., portions of programming code not needed for analysis or that may disrupt model performance, such as user comments), concatenating model input data, compressing model input data, or performing any digital action to prepare model input data for use by the code language processing model. In some embodiments, the code language processing model may be configured based on the model input data (e.g., by an entity performing all or part of process 500). For example, layers and/or nodes may be removed or added to the code language processing model (e.g., based on an amount and/or type of input data).

In some embodiments, the code language processing model may be influenced by the model input data according to a model training process using the model input data. Being influenced may include being dependent upon, being interdependent with, being changed by, being affected by, resulting from, or having a relationship with. The code language processing model may be based on the model input data according to a model training process using the model input data. A model training process may include one or more operations (e.g., iterative operations) performed to improve the code language processing model, including one or more of inputting the model input data to the code language processing model, running the code language processing model through one or more epochs, or modifying a model parameter (e.g., changing a model node, a model layer, or a model connection). In some embodiments, the model training process may include performing iterative operations to improve the code language processing model. For example, the model training process may include running one configuration of the code language processing model through one or more epochs with model input data, analyzing resulting model output, and organizing additional training based on analysis of the model output (e.g., determining model parameters for a second configuration of the code language processing model, determining training parameters such as a number of epochs for the additional training). In some embodiments, the model training process may include running, assessing, and/or training different configurations of the code language processing model concurrently or sequentially.

At step 508, process 500 may analyze at least a part of the body of programming code using the code language processing model. Analyzing at least a part of the body of programming code may include determining a functional effect of the part of the body of programming code within the body of programming code, determining a functional effect of the part of the body of programming code to at least one device (e.g., a functional effect on the operation of at least one device), determining a functional profile of the part of the body of programming code (e.g., determining different potential functional effects, probabilities of functional effects, statistics associated with potential functional effects), determining an intended effect of the part of the body of programming code, determining a natural-language similarity and/or difference between parts of the body of programming code or between the part of the body of programming code and reference code, determining a code-effect similarity and/or difference between parts of the body of programming code or between the part of the body of programming code and reference code, executing the at least a part of the body of programming code, simulating the at least a part of the body of programming code (e.g., simulating execution of the at least a part of the body of programming code on a physical or virtual device), or any other action to determine programming semantics of code. In some embodiments, analyzing at least a part of the body of programming code may include analyzing one or more tokens associated with the at least a part of the body of programming code (e.g., analyzing a complete or partial tokenized representation of the at least a part of the body of programming code). In some embodiments, analyzing the at least a part of the body of programming code may include using the code language processing model to output an encapsulation of functionality of the at least a part of the body of programming code based on the model input data. An encapsulation of functionality may include a representation of effects (e.g., caused by the at least a part of the body of programming code) within a computing environment, which may include metrics (e.g., identifications of, statistics relating to, timelines of) of processor usage, memory usage, time of execution, memory locations accessed, symbols accessed, a sequence of memory locations accessed, a sequence of symbols accessed, a sequence of execution, or any other indicator of usage or change to resources within a computing environment. Additionally or alternatively, an encapsulation of functionality may include a result that the at least a part of the body of programming code is capable of effecting, such as a change to information stored in memory, a modification to an application, an addition of functionality, a removal of functionality, etc. An encapsulation of functionality may be expressed as natural language (e.g., generated through a computerized natural language generation process), graphical elements (e.g., visual depictions of resource usage), an annotated portion of code, or any other digital information indicating effects within a computing environment caused by, or having the potential to be caused by, the at least a part of the body of programming code.

In some embodiments, process 500 may include providing results of the analysis, such as to a local or remote device (e.g., at a display). Results may include one or more of machine-generated natural language text, a graphical depiction of programming semantics of code, a recommended action to influence programming results in a particular way, or any other information determined from the analysis. Process 500 may also include training the code language processing model based on the results of the analysis. Training may include changing model parameters, removing model parameters, adding model parameters, any aspect discussed above with respect to a model training process, or any other computerized action to improve model output of the code language processing model based on the results of the analysis.

In some embodiments, analysis results may be used in subsequent operations or other processes. In some embodiments, process 500 may include identifying a new body of programming code (e.g., an additional body of programming code relative to an initial body of programming code identified at step 502). In some embodiments, the new body of programming code has an associated assembly language. The assembly language associated with the new body of programming code may be the same as, or different from, an assembly language associated with an initial body of programming code identified at step 502. Process 500 may also include applying the code language processing model to analyze the new body of programming code. Applying the code language processing model to analyze the new body of programming code may include identifying one or more portions of the body of programming code which may be associated with a known token. Additionally or alternatively, applying the code language processing model to analyze the new body of programming code may include actions discussed above with respect to steps 504, 506, and/or 508. Process 500 may also include expressing (e.g., after applying the code language processing model, based on applying the code language processing model) at least a part of the new body of programming code using a plurality of tokens associated with the code language processing model. Expressing the at least a part of the new body of processing code using the plurality of tokens may include generating a visual and/or digital representation (e.g., with text, symbols, code language, pictographs, etc.) of the at least a part of the new body of processing code.

In some embodiments, after the analyzing (e.g., step 508), process 500 may include determining at least one canonical representation (discussed above) of at least one of the respective portions of the body of programming code. The determined at least one canonical representation may be included in results of the analysis, which may be provided and/or used in subsequent operations or other processes (as discussed above).

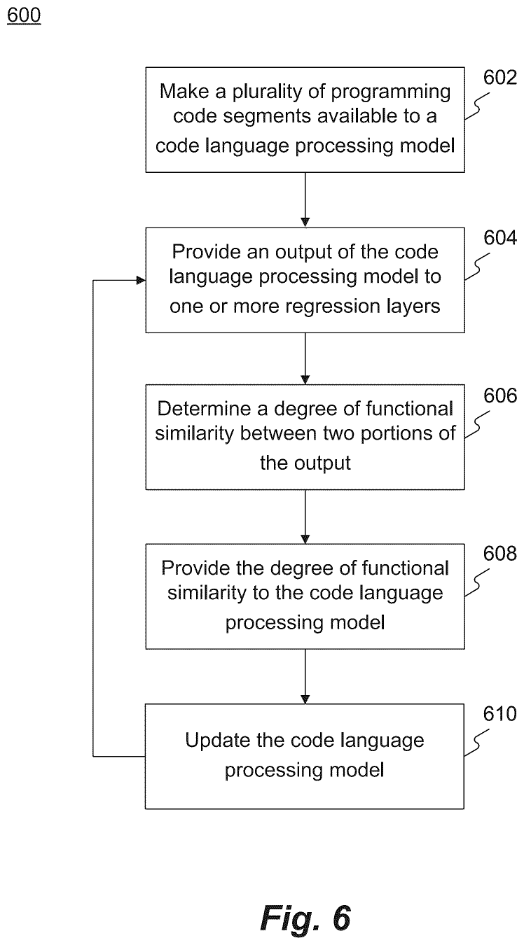

FIG. 6 shows an exemplary process 600 for training code language models. In accordance with disclosed embodiments, process 600 may be implemented in system 100 depicted in FIG. 1, or any type of network environment. For example, process 600 may be performed by at least one processor (e.g., processor 302), memory (e.g., memory 304), and/or other components of modeling provider 102 (e.g., components of one or more modeler devices 300), or by any computing device or IoT system. All or part of process 600 may be implemented in conjunction with all or part of other processes discussed herein (e.g., process 500, process 700, process 800, and/or process 900). For example, after the code language processing model is updated at step 610, it may be used in step 508 to analyze at least a part of a body of programming code. As another example, it may be used in step 708 to generate a prediction. As yet another example, the code language processing model may be configured (e.g., as updated, as un-updated) to associate the plurality of tokens with the respective portions of the body of programming code, to generate a token-based representation of the body of programming code, as discussed with respect to step 904.

At step 602, process 600 may make a plurality of programming code segments available to a code language processing model. A programming code segment may include a function, an argument, an object, a command, an instruction, a programming process, a symbol, or one or more portions of a body of programming code, discussed above with respect to process 500. Making a plurality of programming code segments available to a code language processing model may include one or more of requesting the plurality of programming code segments, accessing the plurality of programming code segments, retrieving the plurality of programming code segments (e.g., from local or remote storage), identifying the plurality of programming code segments (e.g., within a body of programming code), segmenting a body of programming code into the plurality of programming code segments, formatting the plurality of programming code segments to be input to the code language processing model, or inputting the plurality of programming code segments to the code language processing model.

In some embodiments, the code language processing model may include at least one neural network. For example, the code language processing model may include one or more neural layers, which may be connected to each other, consistent with disclosed embodiments. In some embodiments, the at least one neural network may be configured to use at least one attention mechanism. For example, the at least one neural network may include a node that directs attention feedback into the neural network. In some embodiments, the at least one neural network may be configured to operate according to a transformer architecture. For example, the at least one neural network may include one or more transformers, which may be configured to determine correlations and/or relationships between vectors or tokens (e.g., representing programming code segments).

In some embodiments, the code language processing model may be configured to generate an output based on the plurality of programming code segments. In some embodiments, an output generated by the code language processing model may be expressed as (e.g., may include, may reference) at least one token. For example, the output may be expressed as (e.g., may include, may reference) a tokenized representation of the plurality of programming code segments, such as with some or all of the programming code segments being represented by a token. Additionally or alternatively, the output of the code language processing model may be expressed as (e.g., include, reference) a vector. Additionally or alternatively, the output of the code language processing model may be expressed as (e.g., include, reference) a plurality of vectors corresponding to a plurality of tokens. In some embodiments, the plurality of tokens may correspond to the plurality of programming code segments (e.g., each token may correspond to a programming code segment, each token may correspond to at least one programming code segment). Additionally or alternatively, the output of the code language processing model may include code segments (e.g., corresponding to vectors and/or tokens) or indicators of code segments (e.g., pointers). In some embodiments, the output of the code language processing model may include portions associated with separate programs. In some embodiments, generating an output based on the plurality of programming code segments may include aspects described above with respect to step 504. In at least embodiments where at least one vector or at least one token is present in the output of the code language processing model, the output will not be understandable to a human user to determine functional aspects.

At step 604, process 600 may provide the output of the code language processing model to one or more regression layers (e.g., a type of model 316). In some embodiments, process 600 may also provide one or more of the plurality of programming code segments to the one or more regression layers, which may be associated with portions of the output of the code language processing model (e.g. programming code segments may be associated with respective vectors or tokens). In some embodiments, the one or more regression layers may be configured to output respective functional effects of the plurality of programming code segments. In other embodiments, process 600 may provide an output of the code language processing model (and/or programming code segments) to a model 316 different from one or more regression layers, which may also be configured to output respective functional effects of the plurality of programming code segments.

At step 606, process 600 may determine a degree of functional similarity between two portions of the output (e.g., two vectors, two tokens, two code segments). Additionally or alternatively, process 600 may determine a degree of functional similarity between two code segments represented by two portions (e.g., two tokens) of the output. In some embodiments, step 606 may include determining, based on the one or more regression layers, a degree of functional similarity between two portions of the output. For example, the one or more regression layers may be configured to determine the degree of functional similarity between the two portions of the output. In other embodiments, step 606 may include determining, based on a model 316 different from one or more regression layers, a degree of functional similarity between two portions of the output (or code segments represented by the output). For example, the model 316 different from one or more regression layers may be configured to determine the degree of functional similarity between the two portions of the output (or code segments represented by the output). Determining the degree of functional similarity between the two portions of the output (or code segments represented by the output) may include analyzing the plurality of programming code segments and/or tokens associated with the plurality of programming code segments. In some embodiments, the analyzing may include using one or more aspects described above with respect to step 508 and generate a result of the analysis. As another example, the analyzing may include determining a functional effect of each of the plurality of programming code segments. Determining the degree of functional similarity between the two portions of the output (or code segments represented by the output) may include identifying code segments with different formal presentations but identical functionality or code-semantic meaning. By way of a simple non-limiting example, in C, i++ and i+1 are functionality identical, but appear textually different.

In some embodiments, process 600 may determine the degree of functional similarity by feeding test values to programming code (e.g., a function, a program, a module, a script, or any other executable code) corresponding to the two portions of the output; comparing result values from the programming code based on the fed test values; and determining a degree of similarity between the compared result values (e.g., whether the compared result values are the same, a difference between the compared result values, etc.). In some embodiments, process 600 may determine the degree of functional similarity by accessing and/or comparing determined representations (e.g., already determined representations, stored representations) of functionality for portions of programming code. In some embodiments, the programming code corresponding to the two portions of the output may be determined based on the plurality of programming code segments. For example, the programming code corresponding to the two portions of the output may include one or more of the programming code segments (e.g., programming code segments represented by tokens or vectors). By way of further example, the programming code corresponding to the two portions of the output may include one portion that corresponds to one of the programming code segments and another portion that corresponds to another one of the programming code segments. In some embodiments, process 600 may determine the programming code corresponding to the two portions of the output by determining programming code that corresponds to one or more vectors or tokens in the output. Additionally or alternatively, the programming code corresponding to the two portions of the output may be generated based on the plurality of programming code segments.

In some embodiments, the programming code corresponding to the two portions of the output may be associated with a common number of inputs. A common number of inputs may include (e.g., may be) a same number of inputs, a same combination of types of inputs, or a same semantic combination of inputs. For example, the programming code corresponding to the two portions of the output may include a first portion of programming code that is configured with two arguments and a second portion of programming code that is also configured with two arguments (which may be completely the same as, partially the same as, or different from the two arguments of the first portion). In some embodiments, the programming code corresponding to the two portions of the output may be associated with a different number of inputs. A different number of inputs may include (e.g., may be) a different number of inputs, a different combination of types of inputs, or a different semantic combination of inputs. For example, the programming code corresponding to the two portions of the output may include a first portion of programming code that is configured with two arguments and a second portion of programming code that is configured with three arguments (which may or may not overlap with the two arguments of the first portion). As another example, the programming code corresponding to the two portions of the output may include a first portion of programming code that is configured with an input of a function output and a second portion of programming code that is configured with an input of two arguments.

In some embodiments, the programming code corresponding to the two portions of the output may be associated with differing types of inputs. A type of input may be or include a data type, an input length, a variety of argument (e.g., integer, Boolean, string, array), a memory location, a variable, a pointer, a format, or any other trait for differentiating one input from another. For example, the programming code corresponding to the two portions of the output may include a first portion of programming code that is configured with a Boolean argument and a second portion of programming code that is configured with a string argument.

In some embodiments, the programming code corresponding to the two portions of the output may be associated with a common number of outputs. A common number of outputs may include (e.g., may be) a same number of outputs, a same combination of types of outputs, or a same semantic combination of outputs. For example, the programming code corresponding to the two portions of the output may include a first portion of programming code that generates a single integer as an output and a second portion of programming code that also generates a single integer as an output.

In some embodiments, the programming code corresponding to the two portions of the output may be associated with a different number of outputs. A different number of outputs may include (e.g., may be) a different number of outputs, a different combination of types of outputs, or a different semantic combination of outputs. For example, the programming code corresponding to the two portions of the output may include a first portion of programming code that is configured to generate and/or is observed to generate (e.g., based on the fed test values), two integers and a second portion of programming code that is configured to generate and/or or is observed to generate (e.g., based on the fed test values), one integer (which may or may not be the same as one of the two integers).

In some embodiments, the degree of functional similarity may be expressed as a likelihood. For example, process 600 may predict (e.g., using one or more regression layers or another model) that one vector (or token) represents a code segment that is 99% likely to be a functional equivalent of another code segment represented by another vector (or token). Additionally or alternatively, the degree of functional similarity may be expressed as a score, such as an integer indicating a strength of functional similarity between the two portions of the output. In some embodiments, the degree of functional similarity may be expressed as a combination of values. For example, process 600 may determine (e.g., using the one or more regression layers or other model) that the two portions of the outputs are associated with a 90% probability of being functional equivalents, an 8% probability of being at least 95% functionality equivalent, and a 2% probability of being less than 95% functionally equivalent.

At step 608, process 600 may provide the degree of functional similarity to the code language processing model. A degree of functional similarity may include one or more values (e.g., statistics, metrics, probabilities) indicating how similar in functional effect multiple programming code segments are. For example, a degree of functional similarity may include a percentage of 100%, indicating a complete functional similarity (e.g., two programming code segments cause the same result).

In addition to a degree of functional similarity, process 600 may also provide at least one performance value, such as a metric of resource usage, a time of execution, a sequence of execution, or any other information indicating how a programming code segment causes a result. Process 600 may also provide identifiers of the plurality of programming code segments, which may be associated with (e.g., through a data structure or other data linkage) a degree of functional similarity and/or a performance metric.

At step 610, process 600 may update the code language processing model. In some embodiments, step 610 may include updating, based on the degree of functional similarity, the code language processing model. Updating the code language processing model may include changing at least one model parameter (e.g., a model node, a model layer, or a model connection) of the code language processing model, removing at least one model parameter of the code language processing model, or adding at least one model parameter to the code language processing model. In some embodiments, updating the code language processing model may cause the code language processing model to be configured to associate tokens differently than it did prior to the updating. For example, the updated code language processing model may be configured to associate a same token, or two different tokens, with two programming code segments. For example, updating the code language processing model may include configuring the code language processing model to associate a same token for programming code segments that have an exact degree of functional similarity or have a degree of functional similarity above a threshold. Additionally, updating the code language processing model may include configuring the code language processing model to associate a different token for programming code segments that have a degree of functional similarity below a threshold. Additionally or alternatively, updating the code language processing model may include removing a token or vector (e.g., where a single token or vector becomes associated with multiple programming code segments where previously multiple tokens had been). In some embodiments, process 600 may update the model based on multiple degrees of functional similarity, which may be determined for and/or associated with different pairs of programming code segments.

In some embodiments, the code language processing model may be trained or updated based on the determined degree of functional similarity and a missing token training process. For example, a model training process, discussed above with respect to step 506, may be applied to the code language processing model with the determined degree of functional similarity used as a model training input and with one or more tokens removed from the code language processing model. In some embodiments, different tokens may be added and/or removed during different epochs of model training.

In some embodiments, the updated code language processing model may be usable to determine information regarding code segments, which may or may not overlap (partially or completely) with the code segments made available at step 602. In some embodiments, process 600 may include determining, based on the updated code language processing model, that two different segments from the plurality of programming code segments are functionally identical. Two segments may be functionally identical if they are character-by-character identical, are semantically identical, follow identical sequences of execution, produce identical outputs, produce a threshold amount of identical outputs, and/or are determined to operate with a threshold degree of functionality based on static (e.g., statistical) or dynamic (e.g., based on real, non-synthetic data) analysis. Two segments from the plurality of programming code segments may be considered different if they have different names, have different sources, have different structures, and/or exist in different places in memory. In some embodiments, process 600 may include determining, based on the one or more regression layers, that two different segments from the plurality of programming code segments are functionally identical (e.g., as the degree of functional similarity).

In some embodiments, process 600 may include determining, based on the updated code language processing model, that two different segments from the plurality of programming code segments have a similarity score above a threshold. For example, a prompt may be input (e.g., by a user, which may identify the two different segments) to the updated code language processing model that may cause the updated code language processing model to output the similarity score in response. A similarity score may be determined according to machine-observed behavior of the two different segments, based on static analysis, based on dynamic analysis, and/or based on one or more vectors or tokens associated with the two different segments (e.g., one or more vectors or tokens representing the two segments in the updated code language processing model).

In some embodiments, process 600 may include determining, based on the updated code language processing model, a prediction of computing resources needed to execute one or more of the plurality of programming code segments. For example, a prompt may be input (e.g., by a user, which may identify the two different segments) to the updated code language processing model that may cause the updated code language processing model to output the prediction in response. A prediction of computing resources may include an estimation, probability, value, weighted value, statistical expression, or any other information quantifying computing resources associated with one or more of the plurality of programming code segments. For example, prediction of computing resources may include a projected usage of one or more of processing resources, memory resources, disk read or write functions, or bandwidth. The prediction may be expressed as a projection over a span of time, as a peak usage, an average usage, a median usage, a total usage, or any other quantification representing computing resource usage.

In some embodiments, process 600 may include determining, based on the updated code language processing model, a dependency between two or more segments from the plurality of programming code segments. A dependency may include one code segment influencing another, one code segment affecting another (e.g., affecting the functioning, affecting the output, affecting resource usage), one code segment being configured to be an input of another, one code segment being configured to execute only if another code segment is usable, or any relationship between code segments. For example, a function (e.g., one code segment) may include an argument (e.g., a second code segment), which may determine, at least partially, an output of the function.

In some embodiments, process 600 may include determining, based on the updated code language processing model, a vulnerability for a particular segment from the plurality of programming code segments. A vulnerability may include a potential for unintended use, a potential for malicious action, a potential for performing operations outside of a designated set (e.g., accessing protected memory locations, modifying protected code), or a potential for any other action outside of designed execution of the particular segment. A vulnerability may be determined by analyzing execution, a dependency, an interdependency, resource usage, or other trait of one or more of the plurality of programming code segments. The analysis may include comparing one or more traits of the plurality of programming code segments against known threats and/or applying a code test to one or more of the plurality of programming code segments.

In some embodiments, process 600 may include translating a particular segment from the plurality of programming code segments from one programming language into a different programming language. Translating a particular segment may include generating a new code segment that is written in the different programming language, which may have the same functionality as the particular segment. In some embodiments, the translation may be performed in response to a request.

Thus, disclosed embodiments can generate enhanced insights (e.g., predictions, dependency determinations, vulnerability identification, translations between programming languages) through analysis using a model that can interpret, and represent in compact form, functional effects of distinct code segments.

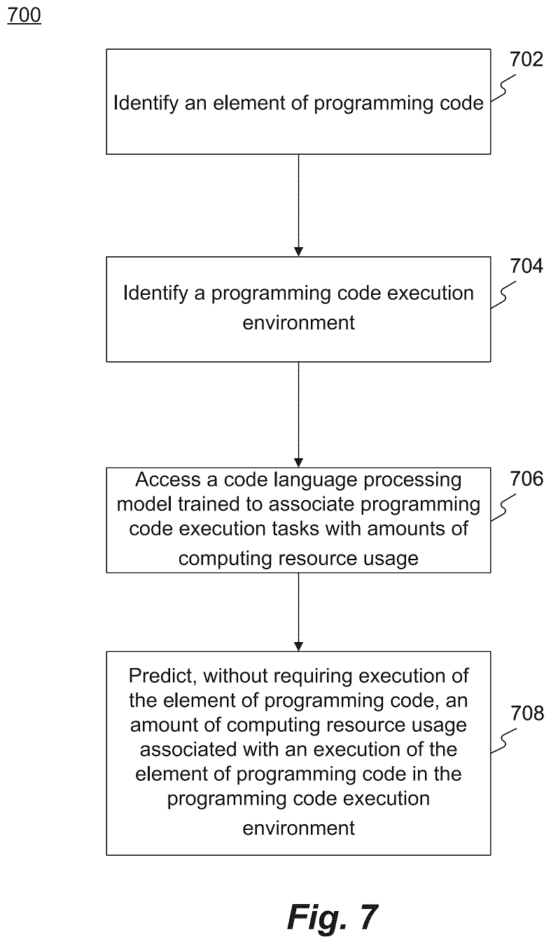

FIG. 7 shows an exemplary process 700 for dynamically predicting resource usage for code changes. In accordance with disclosed embodiments, process 700 may be implemented in system 100 depicted in FIG. 1, or any type of network environment. For example, process 700 may be performed by at least one processor (e.g., processor 302), memory (e.g., memory 304), and/or other components of modeling provider 102 (e.g., components of one or more modeler devices 300), or by any computing device or IoT system. All or part of process 700 may be implemented in conjunction with all or part of other processes discussed herein (e.g., process 500, process 600, process 800, and/or process 900). For example, the code language processing model accessed at step 706 may be trained at least in part using aspects described with respect to process 500 or process 600 (e.g., step 610, the use of a model training process). As yet another example, the code language processing model accessed at step 706 may be trained at least in part using a token-based representation of the body of programming code, as discussed with respect to step 904.

At step 702, process 700 may identify an element of programming code. An element of programming code may include a function, an argument, an object, a command, an instruction, a programming process, or one or more portions of a body of programming code, discussed above with respect to process 500. Identifying the element of programming code may include distinguishing the element of programming code from other elements of programming code (e.g., within a program, within an application, within a script, with a body of code), requesting access to and/or transmission of the element of programming code, accessing the element of programming code (e.g., from a local or remote source), retrieving the element of programming code (e.g., from local or remote storage), determining one or more code compiler markers, delimiting the element of programming code based on one or more code compiler markers, or performing any action to define a portion of programming code. In some embodiments, step 702 may include identifying multiple elements of programming code, which may be associated with (e.g., part of) a same program, application, script, or common body of code.

At step 704, process 700 may identify a programming code execution environment. A programming code execution environment may be any combination of contextual factors that have the potential to influence execution of programming code. For example, the programming code execution environment may include at least one of a firmware version, a type of device, a device model number, an amount of available memory (e.g., RAM, disk space, flash memory space), a memory component storage space size, a system of which a device is a part of, a configuration (e.g., connections between) of devices or systems, a programming language, or a trait of a hardware component. For example, the programming code execution environment may have a defined type of processor (e.g., a processor of a particular model, a processor having a particular number of cores, a processor having a particular clock speed, a processor architecture design). Additionally or alternatively, the programming code execution environment may have a defined type of hardware device (e.g., a controller, a personal computing device, a television, a particular controller model, a particular laptop model, a particular cellphone model, etc.). Additionally or alternatively, the programming code execution environment may have a defined memory space (e.g., a memory space of a particular type and/or size). Process 700 may identify the programming code execution environment based on the element of programming code identified at step 702. For example, process 700 may detect that the element of programming code is written in a particular programming language (e.g., based on an identified syntax and/or key character combinations). Additionally or alternatively, process 700 may identify the programming code execution environment based on a source of the element of programming code. For example, process 700 may determine that the element of programming code was sourced from (e.g., generated by, received from, associated with) a device of a particular model.

At step 706, process 700 may access a code language processing model, which may be trained to associate programming code execution tasks with amounts of computing resource usage. A code language processing model may include any type of model 316, discussed above. A programming code execution task may include one or more functional operations performable by programming code, such as a program, a function, an application, or a script. A computing resource may include any hardware or software element (e.g., present in network architecture 10, present in a device system such as device system 108a, present in computing device 114a, present in modeler device 300) with a finite capacity of performance. An amount of computing resource usage may be expressed as at least one of a total usage during a time period, a rate of usage over a time period, a statistical quantification of usage (e.g., an average usage over a time period, a median usage over a time period, a standard deviation of usage over a time period), or a dynamic representation of usage over a time period (e.g., a collection of data points, a line graph). In some embodiments, the code language processing model may be trained to associate programming code execution tasks with amounts of computing resource usage in the programming code execution environment (e.g., identified at step 704). In some embodiments, for example, the code language processing model may be trained using training data from only the programming code execution environment identified at step 704. As another example, the code language processing model may be trained using training data from a restricted group of programming code execution environments (e.g., programming code execution environments associated with multiple devices, but a single programming language), which may include the programming code execution environment identified at step 704.

In some embodiments, the amount of computing resource usage may be a function of (e.g., based upon, dependent on, influenced by) a particular variable, or of multiple variables. As a first non-limiting and non-exclusive example, the amount of computing resource usage may be a function of processor cycles (e.g., cycles of processor 204). As a second non-limiting and non-exclusive example, the amount of computing resource usage may be a function of memory utilization (e.g., utilization of memory space 200). As a third non-limiting and non-exclusive example, the amount of computing resource usage may be a function of time. As a fourth non-limiting and non-exclusive example, the amount of computing resource usage may be a function of a number of processors (e.g., usage of multiple processors 204). As a fifth non-limiting and non-exclusive example, the amount of computing resource usage may be a function of pipeline usage. As a sixth non-limiting and non-exclusive example, the amount of computing resource usage may be a function of at least one of cache misses or cache hits. In some embodiments, the amount of computing resource usage may be combination of two or more of the variables discussed herein.

In some embodiments, the code language processing model may be trained using one or more tokens or vectors (e.g., which may be associated with programming code, such as those discussed above) as model training input data. In some embodiments, the code language processing model may be trained using a training dataset that includes at least one token, vector, or element of programming code, and a computing resource usage quantifier associated with the at least one token, vector, or element of programming code. For example, the code language processing model may be trained using a training dataset that includes a plurality of pairs of programming elements and associated computing resource usage quantifiers. The training dataset may be associated with a single body of programming code (e.g., a single program, a single application, a single script, etc.) and/or a single programming language, which may help the code language processing model to generate more accurate predictions by not being trained with less relevant data. Alternatively, the training dataset may be associated with multiple bodies of programming code and a single programming language, which may help the code language processing model to generate more insightful predictions by being trained with multiple bodies of code related to the same programming language. Alternatively, the training dataset may be associated with multiple bodies of programming code and multiple programming languages, which may help the code language processing model to generate more insightful predictions by being trained with a large dataset (e.g., where common functionalities across programming languages are interpretable and recognizable to the model). In some embodiments, the code language processing model may be trained using a validation dataset that includes data similar to, but still different from, the training dataset. For example, a validation dataset may include a plurality of pairs of programming elements and associated computing resource usage quantifiers that are different from pairs in the training dataset.

In some embodiments, the code language processing model may include one or more feed-forward neural networks (FFNs), such as neural network configured to only permit information flows in one direction (e.g., without feedback loops, without recursion, without flows back toward a prior node or layer, etc.). This configuration may make the code language processing model more suitable for classifying (e.g., functionality, resource usage, code relationships, etc.) based on inputs and/or identifying patterns. In some embodiments, each of the one or more FFNs may be configured to predict a particular attribute of computing resource usage (or multiple attributes of computing resource usage). For example, one FFN, which may include one or more neural network layers, may be configured to predict an amount of processing resource usage (e.g., central processing unit usage, or CPU usage). Additionally or alternatively, an FFN may be configured to predict an amount of memory resource usage. Additionally or alternatively, an FFN may be configured to predict an amount of interface resource usage (e.g., communications interface usage, bus usage, bandwidth usage).

In some embodiments, the code language processing model may include at least one neural network, consistent with disclosed embodiments. In some embodiments, the at least one neural network may be configured to use at least one attention mechanism, which may direct attention of the code language processing model toward certain inputs or features (e.g., by increasing or decreasing model weights, by adding and/or removing a node, by adding and/or removing a node connection, by adding and/or removing a layer, by adding and/or removing a layer connection). In some embodiments, the output of one portion of a model (e.g., a transformer portion) may be based on intermediate or final outputs from other parts of the code language processing model, such as a feed-forward portion.

In some embodiments, the at least one neural network may be configured to operate according to a transformer architecture. A transformer architecture may include an AI model that includes at least one transformer, such as a model that is configured (e.g., trained) to transform one sequence (or other input) into another, such as by using at least one encoder and at least one decoder (e.g., an encoder-decoder AI model structure).

In some embodiments, the code language processing model may be based on (e.g., include) the code language processing model discussed in process 600 and/or the code language processing model discussed in process 500. For example, a result of analysis performed at step 508 may be used as training or validation data for the code language processing model in process 700. As another example, a result of analysis performed at step 508 may influence the configuration of a model parameter for the code language processing model in process 700. As yet an additional example, output generated by the updated code language processing model from step 610 may be fed an input data, training data, and/or validation data to the code language processing model in process 700. In some embodiments, the code language processing model discussed in process 500 may be part of, or communicably connected to, the code language processing model in process 700. In some embodiments, the code language processing model discussed in process 600 may be part of, or communicably connected to, the code language processing model in process 700.

At step 708, process 700 may predict an amount of computing resource usage associated with an execution of the element of programming code. Predicting an amount of computing resource usage associated with an execution of the element of programming code may include initializing the code language processing model (e.g., accessed at step 706), inputting the element of programming code to the code language processing model, inputting programming code environment information to the code language processing model, configuring the code language processing model (e.g., adjusting model parameters based on the programming code environment), determining a probability of an amount of usage of one or more resources, determining a statistic associated with the element of programming code and an associated amount of computing resource usage (e.g., expressed as described above with respect to step 708), executing the element of programming code, simulating execution of the element of programming code, or any other action to cause the code language processing model to output a prediction. In some embodiments, step 708 may include predicting, without requiring execution of the element of programming code, an amount of computing resource usage associated with an execution of the element of programming code in the programming code execution environment. For example, the code language processing model may be trained to associate a programming code element and/or combinations of programming code elements with different amounts of resource usages (of one or more resource types). In some embodiments the code language processing model may be trained to associate combinations of programming code elements and programming code environments with different amounts of resource usages (of one or more resource types). In some embodiments, the predicting may include converting the element of programming code into a vector representation or tokenized representation, which may be compared to a portion of the code language processing model and/or input to the code language processing model to cause a predictive output.

In some embodiments, the predicting may include matching the element of programming code to an identical match in (or represented by) the code language processing model, which may represent or include one or more elements of programming code, consistent with disclosed embodiments. An identical match may be considered as a situation where process 700 determines that the element of programming code is a functional equivalent to an element of programming code in (or represented by) the code language processing model. Additionally or alternatively, an identical match may be considered as a situation where process 700 determines that the element of programming code is a character-by-character match with an element of programming code in (or represented by) the code language processing model. In some embodiments, predicting may include matching multiple elements of programming code to identical matches in (or represented by) the code language processing model.

In some embodiments, the predicting may include matching the element of programming code to a nearest match in (or represented by) the code language processing model. A nearest match may be considered as a situation where process 700 determines that a particular element of programming code in (or represented by) the code language processing model is, among multiple elements in (or represented by) the code language processing model, the closest functionally to the element of programming code (e.g., including identical or non-identical functionally to the element of programming code). Additionally or alternatively, a nearest match may be considered as a situation where process 700 determines that a particular element of programming code in (or represented by) the code language processing model is, among multiple elements in (or represented by) the code language processing model, the closest character match to the element of programming code (e.g., has the most number of characters in common, has a particular combination of characters in common), which may include, for example, an identical or non-identical character match. In some embodiments, predicting may include matching multiple elements of programming code to nearest matches in (or represented by) the code language processing model.

In some embodiments, the predicting is expressed as a range of values. For example, the predicting may include determining a range of values representing a predicted resource usage associated with the element of programming code (or multiple elements of programming code in some embodiments). By way of further example, the predicting may include determining a range of resource usage values with a particular probability of being used according to the element of programming code (e.g., a 90% probability of the element of programming code using 50-75% of a processing resource, a 95% probability of the element of programming code using 30-40% of available memory). In some embodiments, the predicting may be expressed as at least one of a minimum or maximum value.

Aspects discussed above with respect to an element of programming code may be equally applied to multiple elements of programming code. For example, in some embodiments, step 708 may include predicting an amount of computing resource usage associated with an execution of multiple elements of programming code (e.g., where multiple elements of programming code, which may be part of a common body of programming code, are identified at step 702).

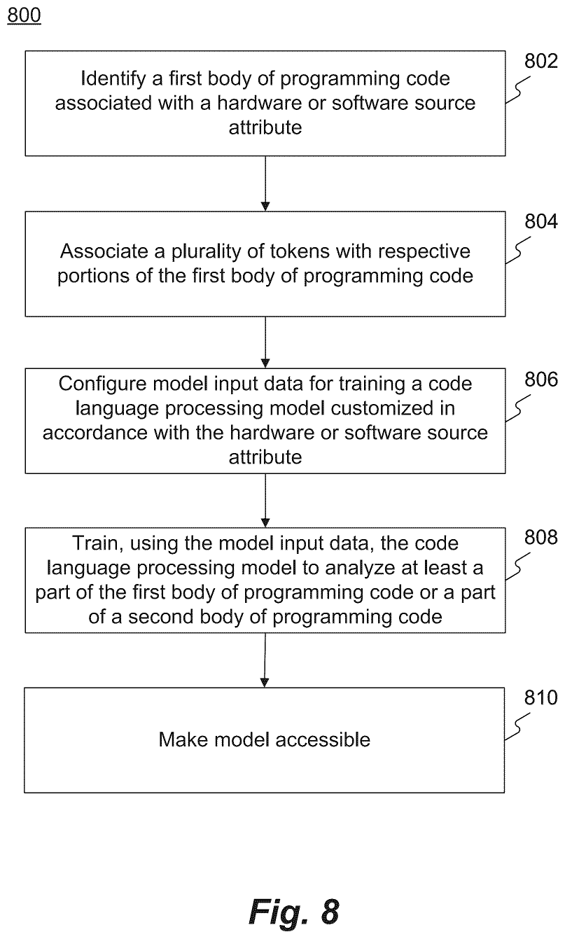

FIG. 8 shows an exemplary process 800 for creating and using tokens representing portions of programming code. In accordance with disclosed embodiments, process 800 may be implemented in system 100 depicted in FIG. 1, or any type of network environment. For example, process 800 may be performed by at least one processor (e.g., processor 302), memory (e.g., memory 304), and/or other components of modeling provider 102 (e.g., components of one or more modeler devices 300), or by any computing device or IoT system. All or part of process 800 may be implemented in conjunction with all or part of other processes discussed herein (e.g., process 500, process 600, process 700, and/or process 900). For example, associating a plurality of tokens with respective portions of the first body of programming code (e.g., at step 804) may include aspects of process 500, such as associating tokens discussed with respect to step 504. As another example, training the code language processing model (e.g., at step 808) may include aspects (e.g., steps) of process 600. As yet another example, the model made accessible at step 810 may be configured for analysis or prediction, such as is discussed with respect to processes 500 and 700, including step 508 and step 708. As yet another example, the code language processing model made accessible at step 810 may be the model used at step 908a.

At step 802, process 800 may identify a first body of programming code associated with a hardware or software source attribute. A first body of programming code may include any aspect of a body of programming code discussed above with respect to step 502. A hardware source attribute may include one or more of an identifier (e.g., alphanumeric sequence) of a piece of hardware (e.g., a component, such as processor 204, a device, such as computing device 114a, a system, such as device system 108c), an identifier of a manufacturer of a piece of hardware, a manufacture date of a piece of hardware, a release date, a model number of a piece of hardware, or any other digital information that differentiates one piece of hardware from another. A software source attribute may include an identifier (e.g., alphanumeric sequence) of a piece of software (e.g., a program, an application, a file, a script, a module, a symbol, a segment of code), an identifier of a software version (e.g., a version number), a revision number, a release date, a software name, or any other digital information that differentiates one piece of software from another. Additionally or alternatively, the hardware or software source attribute may include at least one of: a particular hardware configuration, a particular operating system (OS), a particular programming language, a particular software project (e.g., a software project name), or a particular operating entity (e.g., a developer entity, manufacturer entity, manager entity, creator entity, validation entity, etc.). A body of programming code may be associated with an attribute (e.g., a hardware and/or software source attribute) by including an identifier of the attribute (e.g., within metadata), including a pointer to the attribute, being received or stored with an identifier of the attribute, being linked to an identifier of the attribute in a data structure, or by otherwise having a relationship shown through digital information.

At step 804, process 800 may associate a plurality of tokens with respective portions of the first body of programming code. Associating a plurality of tokens with respective portions of the first body of programming code may include generating a full or partial tokenized representation of the first body of programming code, such as by representing the respective portions of the first body of programming code with tokens, rather than programming code. Additionally or alternatively, associating a plurality of tokens with respective portions of the first body of programming code may include one or more aspects of associating tokens described above with respect to process 500 (e.g., step 504). In some embodiments, process 800 may associate a plurality of tokens with respective portions of the first body of programming code based on previous analysis (e.g., functional equivalence determinations, token associations, common token associations), consistent with disclosed embodiments.

At step 806, process 800 may configure model input data for training a code language processing model customized in accordance with the hardware or software source attribute. In some embodiments, the model input data may include the plurality of tokens (e.g., associated at step 804). Configuring model input data may include configuring model input data for a code language processing model as discussed above with respect to step 506.

At step 808, process 800 may train, using the model input data, the code language processing model to analyze at least a part of the first body of programming code or a part of a second body of programming code. This may produce a customized and trained code language processing model in accordance with the hardware or software source attribute. Training the code language processing model to analyze at least a part of the first body of programming code or a part of a second body of programming code may include a model training process discussed above with respect to step 506. For example, training the code language processing model to analyze at least a part of the first body of programming code or a part of a second body of programming code may include initializing the code language processing model, determining and/or setting model training parameters (e.g., setting model training parameters, such as a number and/or arrangement of layers and/or nodes, weight values, a number of training epochs, etc.), allocating computing resources for training, inputting the input data to the code language processing model, or any other action configured to change or influence the code language processing model.

Analyzing at least a part of a body of programming code (e.g., the first and/or second bodies of programming code) may include determining one or more functional effects of one or more elements of programming code within the body of programming code, determining at least a partial token-representation of the body of programming code, performing a comparison (e.g., a functional comparison) between two bodies of programming code (or portions of bodies of programming code), determining a predicted computing resource usage associated with at least the part of the body of programming code (e.g., according to aspects of process 700), analyzing at least the part of the body of programming code as discussed with respect to step 508, or performing any computerized action to derive information from one or more bodies of programming code.

In some embodiments, the first body of programming code and the second body of programming code may share one or more common attributes, such as a hardware source attribute and/or a software source attribute. As a first non-limiting and non-exclusive example, the first and second bodies of programming code may be associated with a common hardware configuration. In some embodiments, the common hardware configuration may comprise a common device (e.g., a same type of device, a device with a same model or version number, a device with a same name) or a common system (e.g., a same type of system, a system with a same model or version number, a system with a same name). For example, the first and second bodies of programming code may be configured to run (or designated to run, in the case of uncompiled code, for example) on a same device or system. By way of further example, the first and second bodies of programming code may be configured to run (or designated to run) on a same type (e.g., make and model) of controller.

As another non-limiting and non-exclusive example, the first and second bodies of programming code may be associated with a common operating system (OS). For example, the first and second bodies of programming code may be configured to run (or designated for running, in the case of uncompiled code, for example) using a same type of OS. By way of further example, both the first and second bodies of programming code may be configured to run (or designated to run) using a Linux OS.

As another non-limiting and non-exclusive example, the first and second bodies of programming code may be associated with a common programming language. For example, the first and second bodies of programming code may both be associated with, without limitation, C, C+, C++, C#, PHP, Java, JavaScript, or Python.

As another non-limiting and non-exclusive example, the first and second bodies of programming code may be associated with a common software project. A common software project may include a same program, a same application, a same file, a same executable, a same product, a same version (e.g., of any of the foregoing), or any other same portion of programming code.

As another non-limiting and non-exclusive example, the first and second bodies of programming code may be associated with a common operation entity. A common operation entity may include a same software developer, a same manufacturer of a device or system associated with (e.g., configured to run) the first and second bodies of programming code, or a same owner or operator associated with one or more devices associated with (e.g., configured to run) the first and second bodies of programming code.

At step 810, process 800 may make the model accessible. Making the model accessible may include storing the model in a storage medium (e.g., a network resource 104b, which may be a memory space 200), transmitting the model to a device (e.g., a device that is part of a system associated with the hardware or software source attribute, such as a developer of a piece of software or a manufacturer of a piece of hardware, such as remote system 103), notifying a device that the model is available, notifying a device of a storage location of the model, providing a link and/or credential information to access the model to a device, or otherwise permitting a device (e.g., separate from modeling provider 102) to use the model.

In some embodiments, process 800 may include (e.g., as an additional step) analyzing programming code. For example, process 800 may include analyzing, using the code language processing model, the at least a part of the first body of programming code. Additionally or alternatively, process 800 may include analyzing, using the code language processing model, the at least a part of the second body of programming code. Analyzing at least a part of a body of programming code (e.g., the first or second body of programming code) may include determining a functional effect of one or more segments of code in the body of programming code (e.g., based on at least a partially tokenized representation of the body of programming code), determining a degree (e.g., numerical representation) of functional similarity (or difference) between segments of programming code (e.g., within the same body of programming code or different bodies of programming code), determining a reorganization of at least the part of the body of programming code, determining a predicted computing resource usage associated with at least the part of the body of programming code (e.g., according to aspects of process 700), analyzing at least the part of the body of programming code as discussed with respect to step 508, or performing any computerized action to derive information from one or more bodies of programming code.

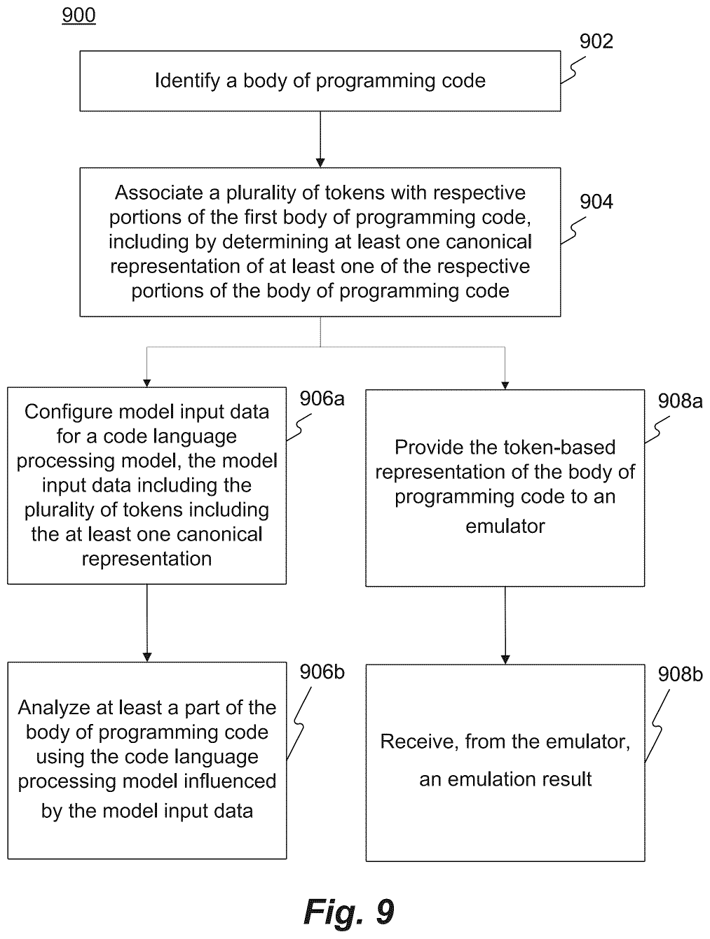

FIG. 9 shows an exemplary process 900 for creating and using tokens representing portions of programming code. In accordance with disclosed embodiments, process 900 may be implemented in system 100 depicted in FIG. 1, or any type of network environment. For example, process 900 may be performed by at least one processor (e.g., processor 302), memory (e.g., memory 304), and/or other components of modeling provider 102 (e.g., components of one or more modeler devices 300), or by any computing device or IoT system. All or part of process 900 may be implemented in conjunction with all or part of other processes discussed herein (e.g., process 500, process 600, process 700, and/or process 800). For example, associating a plurality of tokens with respective portions of the first body of programming code (e.g., at step 904) may include aspects of process 500, such as associating tokens discussed with respect to step 504. As another example, a code language processing model used in process 900 (e.g., at step 908a) may be trained according to aspects (e.g., steps) of process 600 and/or 800. As yet another example, a code language processing model used in process 900 (e.g., at step 908a) may be configured for analysis or prediction, such as is discussed with respect to processes 500 and 700, including step 508 and step 708.

At step 902, process 900 may identify a body of programming code. The body of programming code may include a program, a script, a module, a symbol, a file, binary code, compiled code, uncompiled code, executable code, unexecutable code, any combination thereof, or any amount of computer code (e.g., controller code). Additionally or alternatively, the body of programming code may include any other aspect of identifying a body of programming code, as discussed above with respect to process 500, for example. In some embodiments, the body of programming code may be associated with a particular coding language, compiler, and/or device (e.g., device on which the body of programming code is configured to execute).

Identifying a body of programming code may include one or more of requesting, receiving, verifying, retrieving (e.g., from local or remote storage), extracting, converting, or reformatting the body of programming code, or any other aspect of identifying a body of programming code, as discussed above with respect to process 500, for example.

At step 904, process 900 may associate a plurality of tokens with respective portions of the body of programming code. Portions of the body of programming code may include at least one of a symbol, executable code, unexecutable code, compiled code, uncompiled code, a line of code, a semantically distinct code segment, or any combination thereof. Additionally or alternatively, portions of the body of programming code may include any other aspect of portions of a body of programming code, as discussed above with respect to process 500, for example.

Associating a plurality of tokens with respective portions of the body of programming code may include linking the token with the portion of the body of programming code within a data structure, generating metadata for the token and/or portion of the body of programming code (e.g., metadata for the token that identifies the portion of the body of programming code or visa versa), editing a token library, replacing the portion of the body of programming code with the token (e.g., within a copy of the body of programming code), generating a complete or partial tokenized representation of the body of programming code (e.g., by replacing multiple portions of the body of programming code with respective symbols), or any other digital activity that identifies the token as relevant to the portion of the body of programming code. Additionally or alternatively, associating a plurality of tokens with respective portions of the body of programming code may include any other aspect of associating a plurality of tokens with respective portions of a body of programming code, as discussed above with respect to process 500, for example.

In some embodiments, the associating includes determining at least one canonical representation of at least one of the respective portions of the body of programming code, which may include accessing, requesting, retrieving, and/or generating the at least one canonical representation. The associating may also include associating one or more determined canonical representations with one or more respective portions of the body of code (e.g., associating a plurality of canonical representations with a plurality of respective portions of the body of programming code). In some embodiments, some portions of the body of programming code may not be associated with a canonical representation.

In some embodiments, determining the at least one canonical representation may include determining the at least one canonical representation from among a plurality of canonical representations. For example, a canonical representation may be determined from a library of canonical representations, which may include canonical representations associated with different functionalities, different components, different devices, and/or different code languages (e.g., assembly dialects). In some embodiments each of the canonical representations may represent multiple programming code elements, such as objects, variables, functions, instructions, or symbols (discussed above). In some embodiments, the multiple programming code elements may be associated with different programming languages (e.g., C, C++, Python, etc.). For example, a canonical representation may represent a single functionality and/or a single code-semantic meaning within multiple different programming languages. Additionally or alternatively, the multiple programming code elements may be associated with different bodies of programming code, such as different software programs, different executable files, different uncompiled code files, different modules, and/or different instruction sets.

In some embodiments, associations between the multiple programming code elements and the canonical representations may be determined using the code language processing model. For example, process 900 may apply the code language processing model to the multiple programming code elements to determine canonical representations for respective groups of programming code elements. In some embodiments, the associations between the multiple programming code elements and the canonical representations may be determined by applying the code language processing model to the different bodies of programming code. In some embodiments, a model separate from the code language processing model, which may share characteristics of the code language processing model, may be used to determine canonical representations. For example, a first code language processing model may be configured to determine and/or generate canonical representations, and a second code language processing model may be configured to analyze at least a part of a body of programming code (e.g., at step 906b).

In some embodiments, the at least one canonical representation may represent different code elements (e.g., code elements written in different programming languages) with a same functionality (e.g., functional effect when executed, functional effect when a corresponding compiled code element is executed). In some embodiments, the at least one canonical representation may represent different code elements with functionalities within a similarity threshold range (e.g., execution times, resource usages, functional effects, or a combination thereof, within a threshold range).

In some embodiments, the at least one canonical representation of at least one of the respective portions of the body of programming code may be based on at least one of: comparing instruction sets for different assembly dialects and determining an overlap (e.g., an overlap in functionality and/or code-semantic meaning) of the instruction sets or compiling a programming code portion into multiple assembly dialects to generate multiple instruction sets. In some embodiments, comparing instruction sets (or other type of body of code) for different assembly dialects may include executing different instruction sets and analyzing functional behavior resulting from the execution. Functional behavior may include an execution sequence, an execution time, a memory read and/or write sequence, a memory usage, one or more operations performed, one or more actions taken by a device, or any combination thereof. In some embodiments, a canonical representation may be associated with multiple code elements (e.g., portions of one or more bodies of programming code) when process 900 detects the same or similar functional behavior associated with those code elements.

In some embodiments, process 900 may also include identifying a portion of the body of programming code for token designation. For example, process 900 may determine that a token library does not include a token accurately representing a portion of the body of programming code or that a token designated as representing a portion of the body of programming code was designated in error. In some embodiments, process 900 may determine functionality (e.g., functional behavior) of the identified portion and may, based on the functionality, designate a new token for association with the identified portion. For example, process 900 may associate the new token with the identified portion, where the new token may be included among a plurality of other tokens. In some embodiments, process 900 may associated the new token with multiple identified portions (e.g., portions identified from different bodies of code and/or different programming languages).

In some embodiments, the associating may include (e.g., may result in) generating a token-based representation of the body of programming code, consistent with disclosed embodiments. A token-based representation of the body of programming code may include code-semantic and/or functional representation of the body of programming code that includes one or more tokens, consistent with disclosed embodiments. A token-based representation of the body of programming code may include exclusively tokens or may include at least one token together with other information (e.g., original code from the body of programming code). It is appreciated that a token-based representation may not be understandable to a human and/or may accurately represent the code-semantic meaning and/or functionality of a body of programming code, reducing the need for deep analysis of code.

A canonical representation may include a representation that is applicable across different bodies of programming code and/or across different portions of the same body of programming code. For example, a canonical representation may include a token, string of characters, code object, or any digital expression, that represents functionality (e.g., for execution of code associated with the canonical representation, such as code from which the canonical representation was generated) and/or a code-semantic meaning associated with a portion of the body of programming code. Additionally or alternatively, a canonical representation may include any other aspect of a canonical representation, as discussed above with respect to process 500, for example.

At step 906a, process 900 may configure model input data for a code language processing model. Model input data may include one or more of a vector, a matrix, a token, a file, programming code (e.g., the portion of the body of programming code), a model parameter, or any other digital information for influencing analysis performable by the code language processing model. In some embodiments, the model input data may include the plurality of tokens including the at least one canonical representation. In some embodiments, the model input data may represent the body of programming code in a configuration that is interpretable by the code language processing model. In some embodiments, the model input data is not interpretable by a human. Additionally or alternatively, the model input data may include any aspect of model input data discussed above with respect to process 500, for example.

At step 906b, process 900 may analyze at least a part of the body of programming code using the code language processing model influenced by the model input data. For example, using the code language processing model influenced by the model input data may include feeding the model input data to the code language processing model, which may be configured to interpret the model input data and generate an associated model output, consistent with disclosed embodiments. In some embodiments, a model output may include an indication of predicted resource usage of the body of code, an indication of a predicted execution time of the body of code, an indication of a predicted complexity of the body of code, an indication of a predicted simplification for the body of code, and/or an indication of any analysis of the body of code.

At step 908a, process 900 may provide the token-based representation of the body of programming code (e.g., generated at step 904) to an emulator. An emulator may include a program or other executable software configured to perform the functionality of software designed for a component (e.g., chip), device, or system that is separate from the emulator. Using an emulator may allow a developer to determine (e.g., model) how code will run on a particular component, device, or system without needing to burn the code to that particular component, device, or system. In some embodiments, the emulator may be configured to interpret token-based representations. For example, the emulator may be configured to determine code (e.g., compiled or uncompiled), execution behavior, and/or functionality associated with (e.g., represented by) a token-based representation. By way of further example, the emulator may be configured to determine code that, when executed (or compiled and executed), performs functionality represented by the token-based representation.

At step 908b, process 900 may receive, from the emulator, an emulation result. In some embodiments, an emulation result may include determined code behavior, and/or functionality associated with (e.g., represented by) a token-based representation, discussed above with respect to step 908a. Additionally or alternatively, an emulation result may include a simulation of code (e.g., determined from a token-based representation) and/or statistical information associated with execution of the code.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways. Unless indicated otherwise, “based on” can include one of more of being dependent upon, being responsive to, being interdependent with, being influenced by, using information from, resulting from, or having a relationship with.

For example, while some embodiments are discussed in a context involving electronic controller units (ECUs) and vehicles, these elements need not be present in each embodiment. While vehicle communications systems are discussed in some embodiments, other electronic systems (e.g., IoT systems) having any kind of controllers may also operate within the disclosed embodiments. Such variations are fully within the scope and spirit of the described embodiments.

The disclosed embodiments may be implemented in a system, a method, and/or a computer program product. The computer program product may include a computer-readable storage medium (or media) having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and various procedural programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, or any other alternative ordering, depending upon the functionality involved. Moreover, some blocks may be executed iteratively, and some blocks may not be executed at all. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials will be developed and the scope of the these terms is intended to include all such new technologies a priori.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A non-transitory computer-readable medium including instructions that, when executed by at least one processor, cause the at least one processor to perform operations for dynamically predicting resource usage for code changes, the operations comprising:
identifying an element of programming code;
identifying a programming code execution environment;
accessing a code language processing model, wherein the code language processing model has been trained to associate programming code execution tasks with amounts of computing resource usage; and
predicting, without requiring execution of the element of programming code, an amount of computing resource usage associated with an execution of the element of programming code in the programming code execution environment.

2. The non-transitory computer-readable medium of claim 1, wherein the amount of computing resource usage is a function of processor cycles.

3. The non-transitory computer-readable medium of claim 1, wherein the amount of computing resource usage is a function of memory utilization.

4. The non-transitory computer-readable medium of claim 1, wherein the amount of computing resource usage is a function of time.

5. The non-transitory computer-readable medium of claim 1, wherein the amount of computing resource usage is a function of a number of processors.

6. The non-transitory computer-readable medium of claim 1, wherein the amount of computing resource usage is a function of pipeline usage.

7. The non-transitory computer-readable medium of claim 1, wherein the amount of computing resource usage is a function of at least one of cache misses or cache hits.

8. The non-transitory computer-readable medium of claim 1, wherein the programming code execution environment has a defined type of processor.

9. The non-transitory computer-readable medium of claim 1, wherein the programming code execution environment has a defined type of hardware device.

10. The non-transitory computer-readable medium of claim 1, wherein the programming code execution environment has a defined memory space.

11. A computer-implemented method for dynamically predicting resource usage for code changes, the method comprising:
identifying an element of programming code;
identifying a programming code execution environment;
accessing a code language processing model, wherein the code language processing model has been trained to associate programming code execution tasks with amounts of computing resource usage; and
predicting, without requiring execution of the element of programming code, an amount of computing resource usage associated with an execution of the element of programming code in the programming code execution environment.

12. The computer-implemented method of claim 11, wherein the code language processing model has been trained to associate programming code execution tasks with amounts of computing resource usage in the programming code execution environment.

13. The computer-implemented method of claim 11, wherein the predicting includes matching the element of programming code to an identical match in the code language processing model.

14. The computer-implemented method of claim 11, wherein the predicting includes matching the element of programming code to a nearest, non-identical match in the code language processing model.

15. The computer-implemented method of claim 11, wherein the predicting includes matching the programming code execution environment to an identical match in the code language processing model.

16. The computer-implemented method of claim 11, wherein the predicting includes matching the programming code execution environment to a nearest, non-identical match in the code language processing model.

17. The computer-implemented method of claim 11, wherein the predicting is expressed as a range of values.

18. The computer-implemented method of claim 11, wherein the predicting is expressed as at least one of a minimum or maximum value.

19. The computer-implemented method of claim 11, wherein the code language processing model comprises one or more feed-forward neural networks (FFNs).

20. The computer-implemented method of claim 19, wherein each of the one or more FFNs is configured to predict a particular attribute of computing resource usage.

21. The computer-implemented method of claim 11, wherein the code language processing model comprises at least one neural network.

22. The computer-implemented method of claim 21, wherein the at least one neural network is configured to use at least one attention mechanism.

23. The computer-implemented method of claim 21, wherein the at least one neural network is configured to operate according to a transformer architecture.
